(19) United States
(12) Patent Application Publication
(10) Pub. No.: US 2026/0189666 A1
(43) Pub. Date: Jul. 2, 2026

(54) IMAGE PROCESSING METHOD, IMAGE PROCESSING APPARATUS, AND IMAGE PROCESSING PROGRAM

(71) Applicant: SHARP KABUSHIKI KAISHA, Sakai City (JP)

(72) Inventor: TAKESHI YAMAGUCHI, Sakai City (JP)

(21) Appl. No.: 19/421,662

(22) Filed: Dec. 16, 2025

(30) Foreign Application Priority Data
Dec. 26, 2024 (JP) 2024-230919

(51) Int. Cl. H04N 1/393

(52) U.S. Cl. CPC H04N 1/3935

(57) ABSTRACT

An image processing method is a method for divisional arrangement of a plurality of document image pieces, obtained by dividing a long document image, in a number of pages P smaller than the number of the document image pieces, and presenting and outputting the document image pieces to a user. The method includes: obtaining a size of a short side and a long side of a rearranged sheet in which N × P sheet pieces each having a length of one side obtained by equally dividing any one of long and short sides of an output size by a number of divisions N, and having a length of another side that is equal to a length of another one of the sides of the output size, in a direction along the other side; determining whether the sheet pieces fit within the rearranged sheet with the actual size or by zooming to match with any one of the short side and the long side of the rearranged sheet; determining, as an outputtable arrangement, when determined to fit, a divisional arrangement including document image pieces divided at a position corresponding to the sheet pieces; and setting an image of the P pages arranged in the order of the original long document image as an outputtable image.

### DESCRIPTION

### FIELD OF THE INVENTION

The present invention relates to an image processing method, an image processing apparatus, and an image processing program, and more particularly, to an image processing method, an image processing apparatus, and an image processing program for dividing a long document image having an aspect ratio different from that of an output size to fit the output size.

### BACKGROUND ART

For example, the following processing is known as processing in a case where the aspect ratio differs between a sheet size of a document or on a driver program or an application software program (hereinafter, referred to as an application) operating on a computer (hereinafter, referred to as a document including the sheet size on an application) and a sheet size to be output (output size).

A setting screen of a printer driver of a printer capable of using roll paper as a printing sheet is provided with an option of "match with width of roll paper" as one of the settings of document scale printing. When the selection of "match with width of roll paper" is received, the document is scaled in accordance with the width of the roll paper.

The following method is known as a method of calculating a sheet size in spreadsheet software. First, a reference sheet size is set. Then, a size is obtained with which all the cells with spreadsheet data in a spreadsheet document fit within a single page. Then, the number of pages is acquired by which the size is divided in the horizontal direction and the vertical direction based on the reference sheet size (for example, X pages in the horizontal direction and Y pages in the vertical direction). Then, the size of a dummy sheet having a width of the reference sheet size (width) × X and a height of the reference sheet size (height) × Y is calculated. Next, the dummy sheet size obtained as described above is repeatedly reduced by a predetermined ratio (for example, 10%) at a time, until it is determined that the width and the height fit within one page. Thus, the minimum reduction ratio by which the entire cell range with the spreadsheet data can fit within one page is acquired. Then, the acquired reduction ratio is applied to the dummy sheet size to set the dummy sheet size as the sheet size. The printer driver is set to change the magnification so that a document of the sheet size is printed over the entire width of the roll paper loaded in the printer.

The following technique is also known. Whether a print protrusion occurs is checked on a table output device before printing. When the protrusion occurs, the progress of printing to a point where the protrusion occurs triggers automatic folding back when there is a margin for folding back on the paper, and the printing is performed within the sheet. If the margin does not exist, the rest is printed after the sheet is updated.

### SUMMARY

### Technical Problem

When a document image longer than a standard size (hereinafter, referred to as a long document image) is printed on a standard size sheet or the like having a different aspect ratio, a user needs to determine whether to divide or reduce the long document image. In this case, the printing is preferably performed without division or reduction, leading to difficulty in reading the information included in the long document image. Alternatively, the margin is reduced as much as possible so as not to use the sheet wastefully.

According to the method of PTL 1, an image can be reduced and printed so as to fit within a sheet. Still, the printing sheet is limited to roll paper. In addition, since the image of the document is reduced while predominantly focusing on matching the width of the document with the width of the roll paper, information such as characters on the document may become too small to read.

With the method of PTL 2, the spreadsheet data can be printed on a sheet, with the minimum reduction ratio for fitting the entire cell range with the spreadsheet data within a single page. In addition, since the image of the document is reduced while predominantly focusing on the fitting within a single page, information such as characters on the document may become too small to read. Furthermore, a useless margin may be formed.

With the method of PTL 3, when an image protrusion occurs, if there is a margin for folding, that is, a blank, the image can be folded and printing can be performed within a sheet without any protrusion. Still, the image involving a protrusion is simply folded if there is a margin, without taking into consideration the resizing ratio and the number of folding backs. When there is no margin for folding, printing is performed on a plurality of sheets, and thus, a plurality of sheets are required. Furthermore, a useless margin may be formed.

The present invention has been made in view of the above circumstances, and provides a method of determining a divisional arrangement of a long document image so that the number of pages is smaller than the number of document image pieces obtained by dividing the long document when the long document is divided in the longitudinal direction for output to a page with a different aspect ratio.

### Solution to Problem

The present invention provides an image processing method for divisional arrangement of a plurality of document image pieces, obtained by dividing a long document image, into a number of pages P smaller than number of the document image pieces, the image processing method comprising, by a processor: obtaining, for one output size or more, a size of a rearranged sheet in which N × P sheet pieces each having a length of one side obtained by equally dividing any one of vertical and horizontal sides of the output size by a number of divisions N, and having a length of another side that is equal to a length of another one of the sides of the output size, in a direction along the other side; determining whether the long document image of an actual size fits within the size of the rearranged sheet, and when the long document image fits within the size, determining, as an outputtable arrangement, a divisional arrangement including a plurality of actual size document image pieces obtained by dividing the long document image at a position corresponding to each sheet piece; determining whether the long document image fits within the size of the rearranged sheet when the long document image is zoomed to match the size of any of the short side and the long side of the rearranged sheet, and when the long document image fits within the size, determining, as an outputtable arrangement, a divisional arrangement including a plurality of zoomed document image pieces obtained by dividing the zoomed long document image at a position corresponding to each sheet piece; and obtaining, as an outputtable image, an image of the P pages in which a maximum of N document image pieces according to the divisional arrangement determined to be outputtable are arranged per page in an arrangement order of the original long document image, wherein N and P are both natural numbers.

Another aspect of the disclosure relates to an image processing apparatus for divisional arrangement of a plurality of document image pieces, obtained by dividing a long document image, into a number of pages P smaller than number of the document image pieces, the image processing apparatus comprising: a document image acquirer that acquires the long document image; an image processor that generates an image obtained by divisionally arranging the long document image acquired; and an image outputter that outputs the image, wherein the image processor includes a rearrangement output size calculator that obtains, for one output size or more, a size of a rearranged sheet in which N × P sheet pieces each having a length of one side obtained by equally dividing any one of vertical and horizontal sides of the output size by a number of divisions N, and having a length of another side that is equal to a length of another one of the sides of the output size, in a direction along the other side, an actual size document divider that determines whether the long document image of an actual size fits within the size of the rearranged sheet, and determines, when the long document image fits within the size, a divisional arrangement including a plurality of actual size document image pieces obtained by dividing the long document image at a position corresponding to each sheet piece as an outputtable arrangement, a zoom document divider that determines whether the long document image fits within the rearranged sheet when the long document image is zoomed and superimposed to match the size of any of the short side and the long side of the rearranged sheet, and when the long document image fits within the size, determines, as an outputtable arrangement, a divisional arrangement including a plurality of zoomed document image pieces obtained by dividing the zoomed and superimposed long document image at a position corresponding to each sheet piece, and a divisional arrangement determiner that obtains, as an outputtable image, an image of the P pages in which a maximum of N document image pieces according to the divisional arrangement determined to be outputtable are arranged per page in an arrangement order of the original long document image, the image outputter outputs any of the outputtable images, and N and P are both natural numbers.

Another aspect of the disclosure relates to an image processing program for divisional arrangement of a plurality of document image pieces, obtained by dividing a long document image, into a number of pages P smaller than number of the document image pieces, the image processing program causing a processor to execute processing comprising: obtaining, for one output size or more, a size of a rearranged sheet in which N × P sheet pieces each having a length of one side obtained by equally dividing any one of vertical and horizontal sides of the output size by a number of divisions N, and having a length of another side that is equal to a length of another one of the sides of the output size, in a direction along the other side; determining whether the long document image of an actual size fits within the size of the rearranged sheet, and when the long document image fits within the size, determining, as an outputtable arrangement, a divisional arrangement including a plurality of actual size document image pieces obtained by dividing the long document image at a position corresponding to each sheet piece; determining whether the long document image fits within the size of the rearranged sheet when the long document image is zoomed to match the size of any of the short side and the long side of the rearranged sheet, and when the long document image fits within the size, determining, as an outputtable arrangement, a divisional arrangement including a plurality of zoomed document image pieces obtained by dividing the zoomed and superimposed long document image at a position corresponding to each sheet piece; and obtaining, as an outputtable image, an image of the P pages in which a maximum of N document image pieces according to the divisional arrangement determined to be outputtable are arranged per page in an arrangement order of the original long document image, wherein N and P are both natural numbers.

### Advantageous Effects of Disclosure

The image processing method according to the disclosure includes determining, as an outputtable arrangement, a divisional arrangement of a plurality of document image pieces, of an actual size or zoomed, obtained by dividing a long document image at a position corresponding to each sheet piece, and setting, as an outputtable image, an image of P pages in which a maximum of N document image pieces are arranged per page in the arrangement order of the original long document image. Thus, a divisional arrangement of a long document image can be determined so that the number of pages is smaller than the number of document image pieces when the long document is divided in the longitudinal direction for output to a page with a different aspect ratio.

The image processing apparatus and the image processing program according to the disclosure also provide the same effect.

### BRIEF DESCRIPTION OF THE DRAWINGS

FIG. 1 is a block diagram illustrating a configuration of an image processing apparatus illustrated as an example of an image processing apparatus in the present disclosure.

FIG. 2 is an external perspective view of a portion of the image processing apparatus illustrated in FIG. 1, corresponding to a document reader.

FIG. 3 is an explanatory diagram illustrating an example of reception of a change in page setting on a preview screen 31 displayed on an operation inputter of the image processing apparatus according to an embodiment of the present disclosure.

FIG. 4A is an explanatory diagram illustrating an example of a long image document according to the present disclosure.

FIG. 4B is an explanatory diagram illustrating an example of a sheet (output size) according to the present disclosure.

FIG. 5A is an explanatory diagram schematically illustrating an example of a procedure of divisional arrangement according to the present disclosure. (example of output size with short side divided)

FIG. 5B is an explanatory diagram schematically illustrating another example of a procedure of divisional arrangement according to the present disclosure. (example of output size with long side divided, with short side of sheet being short side of rearranged sheet)

FIG. 5C is an explanatory diagram schematically illustrating still another example of a procedure of divisional arrangement according to the present disclosure. (example of output size with long side divided, with short side of sheet being long side of rearranged sheet, and with document image arrangement involving rotation)

FIG. 6 is an explanatory diagram illustrating an example of a rearranged sheet according to the present disclosure.

FIG. 7 is an explanatory diagram illustrating an example of determining a document image piece with a long document image in FIG. 4A superimposed on the rearranged sheet in FIG. 6 (document is of the actual size).

FIG. 8 is an explanatory diagram illustrating an example of determining the document image piece with the long document image in FIG. 4A superimposed on the rearranged sheet in FIG. 6 (document is zoomed for long side matching).

FIG. 9 is an explanatory diagram illustrating an example of determining the document image piece with the long document image in FIG. 4A superimposed on the rearranged sheet in FIG. 6 (document is zoomed for short side matching).

FIG. 10 is an explanatory diagram illustrating an example of a long image document that is vertically long according to the present disclosure.

FIGS. 11A and 11B are explanatory diagrams illustrating examples of the rearranged sheet according to the present disclosure, in which FIG. 11A illustrates a case of sheet long side division, with the short side of the sheet matching the long side of the rearranged sheet, and FIG. 11B illustrates a case of sheet long side division, with the short side of the sheet matching the short side of the rearranged sheet.

FIG. 12 is an explanatory diagram illustrating an example of determining a document image piece with a long document image in FIG. 10 superimposed on the rearranged sheet in FIG. 11A (document is of the actual size).

FIG. 13 is an explanatory diagram illustrating an example of determining the document image piece with the long document image in FIG. 10 superimposed on the rearranged sheet in FIG. 11A (document is zoomed for short side matching).

FIG. 14 is an explanatory diagram illustrating an example of determining the document image piece with the long document image in FIG. 10 superimposed on the rearranged sheet in FIG. 11A (document is zoomed for long side matching).

FIG. 15 is an explanatory diagram illustrating an example of determining a document image piece by rotating the long document image in FIG. 10 for matching the orientations of the short sides with each other and the orientations of the long sides with each other, and superimposing the long document image on the rearranged sheet in FIG. 11B (document is of the actual size).

FIG. 16 is an explanatory diagram illustrating an example of determining a document image piece by rotating the long document image in FIG. 10 for matching the orientations of the short sides with each other and the orientations of the long sides with each other, and superimposing the long document image on the rearranged sheet in FIG. 11B (zoomed for long side matching).

FIG. 17 is an explanatory diagram illustrating an example of determining a document image piece by rotating the long document image in FIG. 10 for matching the orientations of the short sides with each other and the orientations of the long sides with each other, and superimposing the long document image on the rearranged sheet in FIG. 11B (zoomed for short side matching).

FIG. 18 is an explanatory diagram illustrating an example of presenting, to a user, candidates for a feasible recommended divisional arrangement based on the setting illustrated in FIG. 3.

FIG. 19 is a first flowchart illustrating a flow of processing in which an image processor determines and presents a candidate for the divisional arrangement based on the setting illustrated in FIG. 3.

FIG. 20 is a second flowchart illustrating a flow of processing subsequent to FIG. 19.

FIG. 21 is a third flowchart illustrating a flow of processing subsequent to FIG. 20.

FIG. 22 is a fourth flowchart illustrating a flow of processing subsequent to FIG. 21.

FIG. 23 is an explanatory diagram illustrating a condition of page setting different from that in FIG. 3.

FIG. 24 is an explanatory diagram illustrating an example of presenting, to a user, candidates for a feasible divisional arrangement based on the setting illustrated in FIG. 23.

FIG. 25 is a first flowchart illustrating a flow of processing in which an image processor determines and presents a candidate for the divisional arrangement based on the setting illustrated in FIG. 23.

FIG. 26 is a second flowchart illustrating a flow of processing subsequent to FIG. 25.

FIG. 27 is a second flowchart illustrating a flow of processing subsequent to FIG. 26.

FIG. 28 is a second flowchart illustrating a flow of processing subsequent to FIG. 27.

### DESCRIPTION OF EMBODIMENTS

The present invention will be described below in further detail with reference to the drawings. Note that the following description is illustrative in all aspects, and it should not be understood that the description restricts the invention.

### EXAMPLE OF APPARATUS EXECUTING PROCESSING OF OUTPUTTING IMAGE IN DIVISIONAL ARRANGEMENT

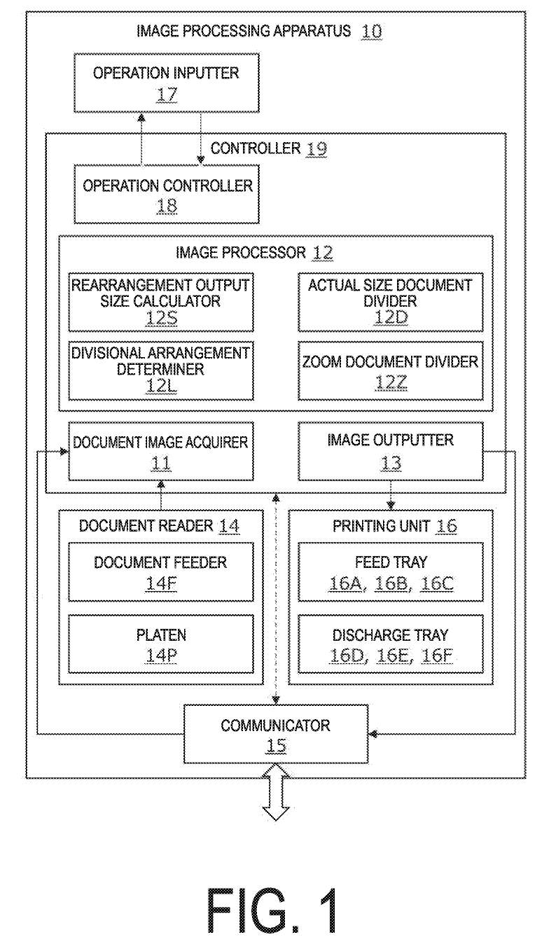

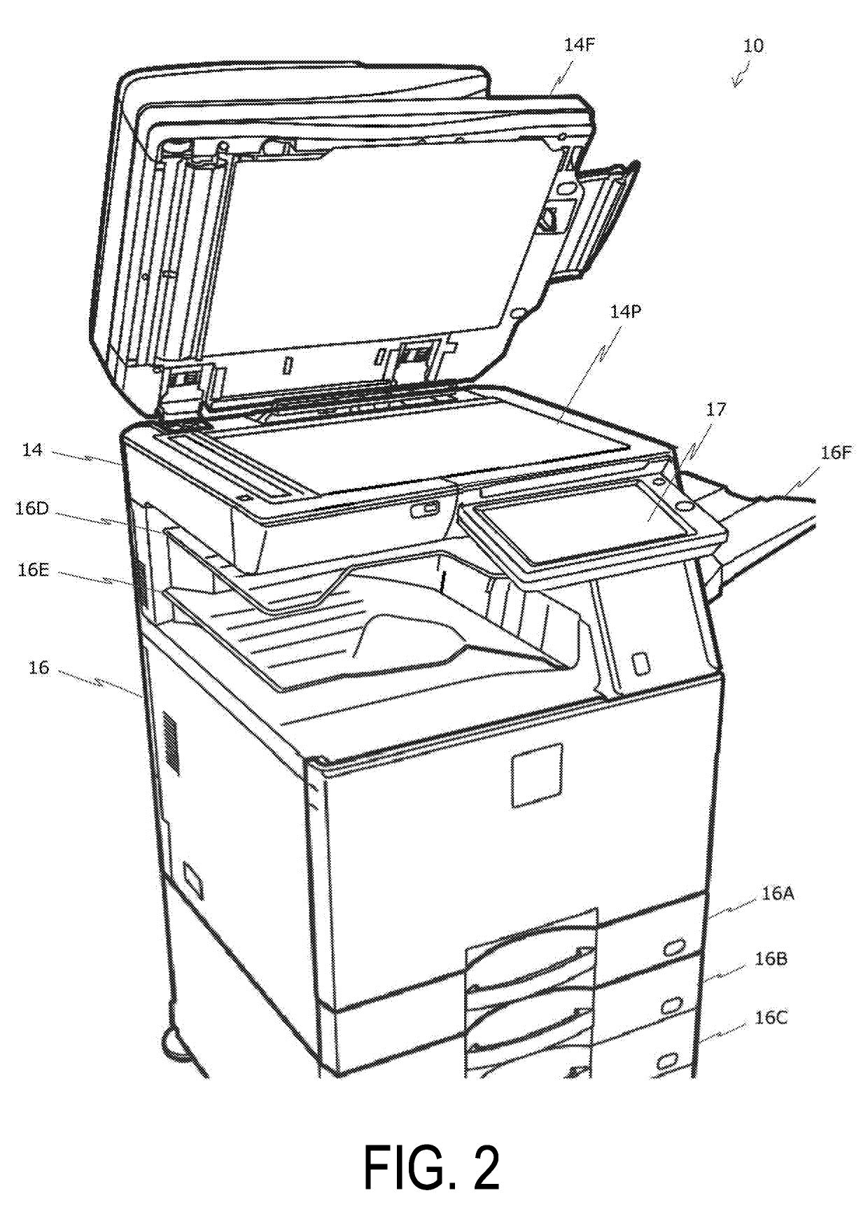

First, an image processing apparatus according to the present disclosure will be described. The image processing apparatus is an example of an apparatus executing an image processing method according to the present disclosure. However, this is merely an example, and the image processing method according to the present disclosure is not limited to the image processing apparatus, and may be executed by other types of apparatuses. For example, the scope of the present disclosure further includes a mode in which a processor executes an installed driver program or application in an information processing apparatus such as a personal computer (PC) or a smartphone. The application may be of any type as long as it handles an input image as a document and an output image and includes processing related to the layout of the input image and the output image. Referring back to the description on the image processing apparatus, FIG. 1 is a block diagram illustrating a configuration of the image processing apparatus according to the present disclosure. FIG. 2 is an external perspective view of a portion of the image processing apparatus illustrated in FIG. 1, corresponding to a document reader.

As illustrated in FIG. 1, an image processing apparatus 10 includes a document reader 14, a communicator 15, a printing unit 16, an operation inputter 17, and one or more controllers 19. The one or more controllers 19 control the entirety of the image processing apparatus 10. The one or more controllers 19 realize various functions related to document reading and jobs related to printing and the like, that is, a series of image processes, by reading and executing various control programs stored in a memory (not illustrated in FIG. 1). The controller 19 also performs recognition of an operation on the operation inputter 17 and display control. Further, the controller 19 controls communication with external devices connected via the communicator 15. The one or more controllers 19 may be implemented by one or a plurality of processors (such as a central processing unit (CPU) or a system on a chip (SoC)). The one or more controllers 19 may include one or a plurality of circuits. The software resources and the hardware resources cooperate with each other to implement the functions of the one or more controllers 19 that control the image processing apparatus 10.

The one or more controllers 19 according to the present disclosure include a document image acquirer 11, an image processor 12, an image outputter 13, and an operation controller 18. The operation controller 18 included in the one or more controllers 19 is connected to the operation inputter 17, recognizes a user operation received by the operation inputter 17, and causes the operation inputter 17 to display an operation screen or a message. As illustrated in FIG. 2, the operation inputter 17 is provided on the front side of the image processing apparatus 10. The operation inputter 17 includes a display and an operation detection device. As the display device, for example, a liquid crystal display device or an organic light emitting display (OLED) can be applied, and as the operation detection device, a touch panel can be applied. The display device displays the operation screen generated by the operation controller 18. The operation detection device detects a user operation on the operation screen.

The document image acquirer 11 acquires image data of a document read by the document reader 14. Alternatively, the document image acquirer 11 can also acquire image data by receiving data from an external device connected via the communicator 15.

The image processor 12 executes processing related to the acquired image data. The image processor 12 includes an actual size document divider 12D, a zoom document divider 12Z, a rearrangement output size calculator 12S, and a divisional arrangement determiner 12L. The rearrangement output size calculator 12S assumes the following sheet pieces. A side of a 1/N length as a result of equally dividing any one of vertical and horizontal sides (a side extending in the vertical direction, for example) of a sheet of a size corresponding to the output size by N is defined as a side in this direction (vertical direction). Further, a side of the same length as the length of a side of the output size without the equal dividing (a side extending in the horizontal direction) is defined as a side in this direction (horizontal direction). Based on this assumption, the vertical and horizontal sizes of rearranged sheets are calculated with N × P sheets arranged in the direction (horizontal direction) of the side without equal division. N and P are both natural numbers. An example of specific processing will be described below. The actual size document divider 12D executes processing of determining document image pieces obtained by dividing a long document image at positions corresponding to the respective sheet pieces when the long document image fits within a rearranged sheet of a size calculated by the rearrangement output size calculator 12S, when the long document image of the actual size is superimposed on the rearranged sheet. The zoom document divider 12Z executes processing of determining document image pieces obtained by dividing the long document image at positions corresponding to the respective sheet pieces of the rearranged sheet of the size calculated by the rearrangement output size calculator 12S. In this case, it is required that the long document image fits within the rearranged sheet when the long document image zoomed to match the size of the rearranged sheet in any of the longitudinal and horizontal directions is superimposed. The divisional arrangement determiner 12L presents, to the user, an image of P pages in which the document image pieces of an actual size or zoomed are arranged in the arrangement order in the long document image as an outputtable divisional arrangement based on the division thus determined. Alternatively, the divisional arrangement determiner 12L executes the processing of determining the divisional arrangement based on a predetermined condition. A maximum of N document image pieces are arranged in each page.

The image outputter 13 outputs an output size image based on the divisional arrangement determined by the image processor 12 through reception of the user selection or based on a predetermined condition.

For example, in the case of a print job, the document image acquirer 11 acquires image data from an external device via the communicator 15, the image processor 12 executes image processing for printing, and the image outputter 13 causes the printing unit 16 to output an image. For example, in the case of a copy job, the document image acquirer 11 acquires image data of a document read by the document reader 14, the image processor 12 executes image processing for printing, and the image outputter 13 causes the printing unit 16 to output an image. For example, in the case of a scan job, the document image acquirer 11 acquires image data of a document read by the document reader 14, and the image processor 12 executes processing of generating an image in a predetermined data format. The image outputter 13 transmits the image data to the external device via the communicator 15, or stores the image data in a memory of the image processing apparatus 10.

The document reader 14 reads an image of a document under the control of the one or more controllers 19, converts the image into a color image signal (RGB analog signal) of red, green, and blue (RGB), and outputs the color image signal to the document image acquirer 11. That is, the document reader 14 executes image reading processing in the copy job and the scan job. The document to be read is set on a document feeder 14F or a platen 14P by the user. The document feeder 14F conveys the set documents one by one to a predetermined reading position. The platen 14P is formed of a flat and transparent glass member. The document reader 14 includes an image sensor (not illustrated in FIGS. 1 and 2). The document reader 14 also includes a scanning mechanism (not illustrated in FIGS. 1 and 2) for scanning a document placed on the platen 14P.

The printing unit 16 feeds printing sheets one by one from any one of feed trays 16A, 16B, and 16C that store printing sheets, prints images output from the image outputter 13 on the printing sheets, and outputs the printing sheets to discharge trays. As illustrated in FIGS. 1 and 2, the image processing apparatus 10 outputs the printing sheets after the printing to any one of three discharge trays 16D, 16E, and 16F.

### First Embodiment

### Example of Scene of Executing Processing of Outputting Image in Divisional Arrangement

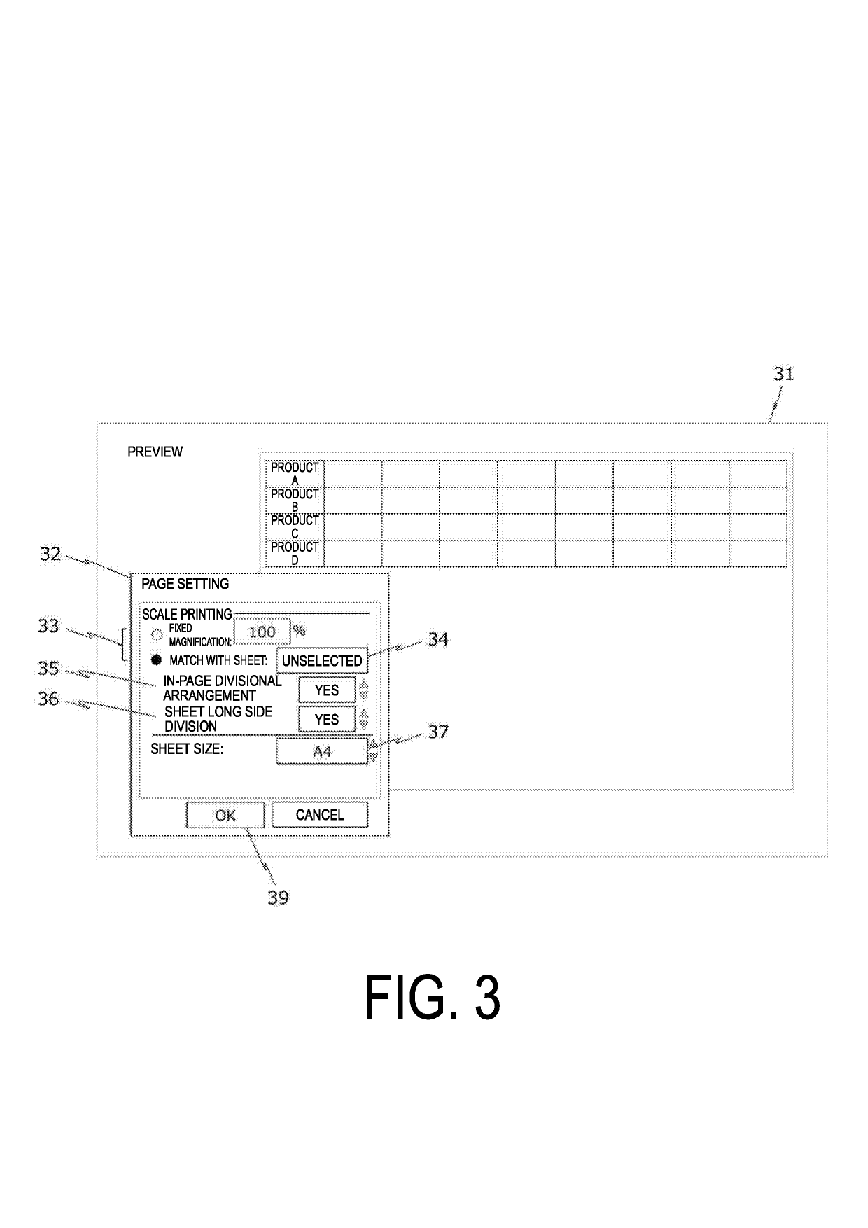

Next, an example of a scene of executing processing according to the present disclosure for outputting an image in a divisional arrangement will be described. Here, an example is illustrated in which the user selects a setting for achieving divisional arrangement of a long document in a copy job executed by the image processing apparatus 10. FIG. 3 is an explanatory diagram illustrating a state in which a page setting screen 32 for receiving a user operation of changing to a desired page setting is pop-up displayed on a preview screen 31 for a copy job displayed on the operation inputter 17 of the image processing apparatus 10. A state is illustrated in which a horizontally long document does not fit within one page, and the preview screen 31 displays the page setting screen 32 as a result of the user operating an operation button not illustrated in FIG. 3. The page setting screen 32 includes radio buttons 33 corresponding to a setting item for receiving selection of a fixed magnification or adjustment to a sheet, that is, the output size. Further, the setting is received for an item 34 about whether the method of adjustment to the sheet has been selected, an item 35 about in-page divisional arrangement, an item 36 about whether the long side of the sheet is divided, and an item about the sheet size 37.

The item 35 about the in-page divisional arrangement is an item assuming a long document according to the present disclosure, and is a setting about whether to divisionally arrange the document image pieces in accordance with the sheet pieces obtained by equally dividing one page of the sheet into a plurality of sheet pieces. The item 36 about dividing the long side of the sheet is a setting on whether to consider the divisional arrangement of the sheet pieces obtained by equally dividing the long side of the sheet in addition to the basic sheet pieces obtained by equally dividing the short side of the sheet when the item 35 about the in-page divisional arrangement is set to "YES". In the example illustrated in FIG. 3, the radio button 33 is selected for zooming the document for the adjustment to the sheet. The A4 of the standard size is set as the sheet size 37, the in-page divisional arrangement 35 is set to "YES", and the long side division 36 of the sheet is set to "YES". The item 34 about whether the method of adjustment to the sheet has been selected is displayed as "NOT SELECTED". When "NOT SELECTED" is pressed, a selection screen for selecting a method of adjustment to the sheet is displayed. When one is selected thereon, the display returns to the screen illustrated, with "SELECTED" displayed for the item 34 about whether the method of adjustment to the sheet has been selected. Further, the gray-out of an "OK" key 39 at the lower end of the page setting screen 32 is released, whereby the key is displayed normally to be operable. Further, the preview screen 31 is changed to a preview according to the set condition. When the "OK" key 39 is operated to confirm the setting, the user who has confirmed the finish on the preview screen operates an operation button (not illustrated), whereby an image corresponding to the preview is output.

### Example of Processing of Divisionally Arranging and Outputting Image

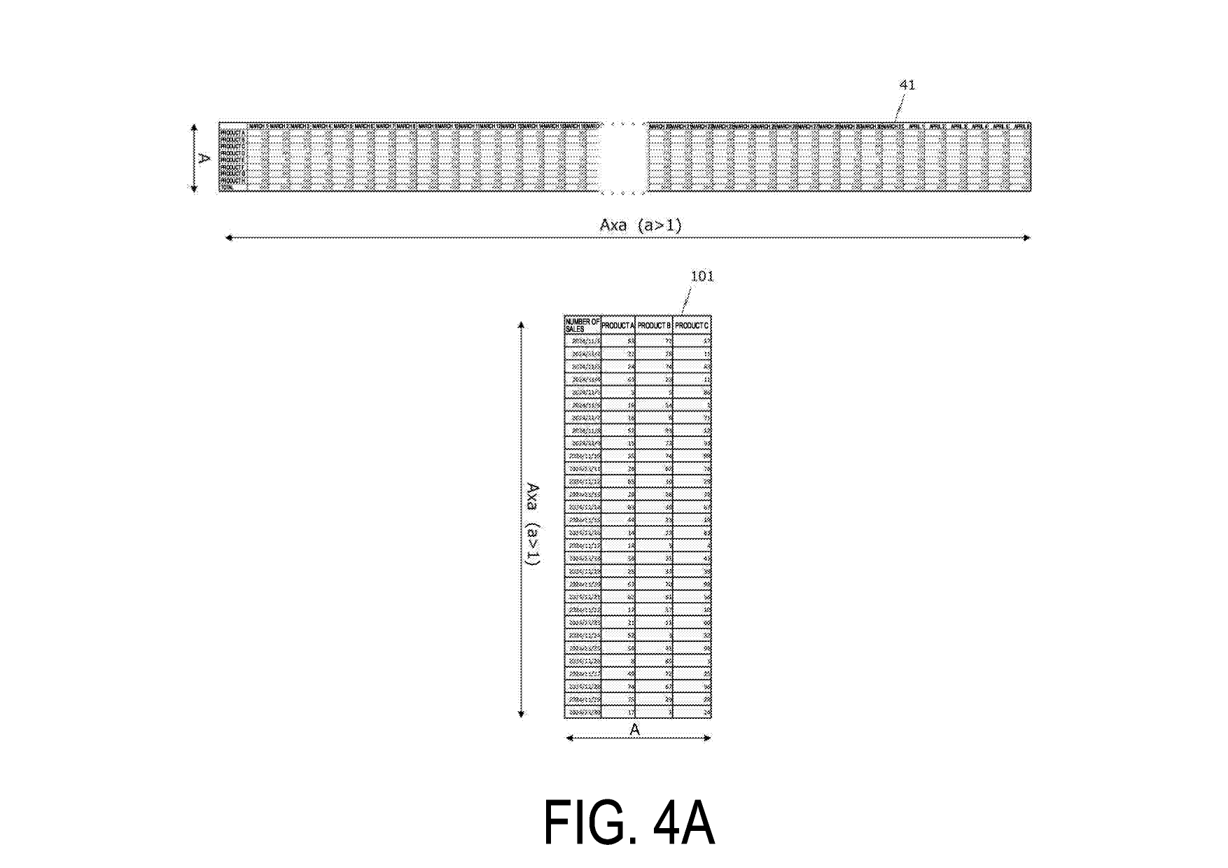

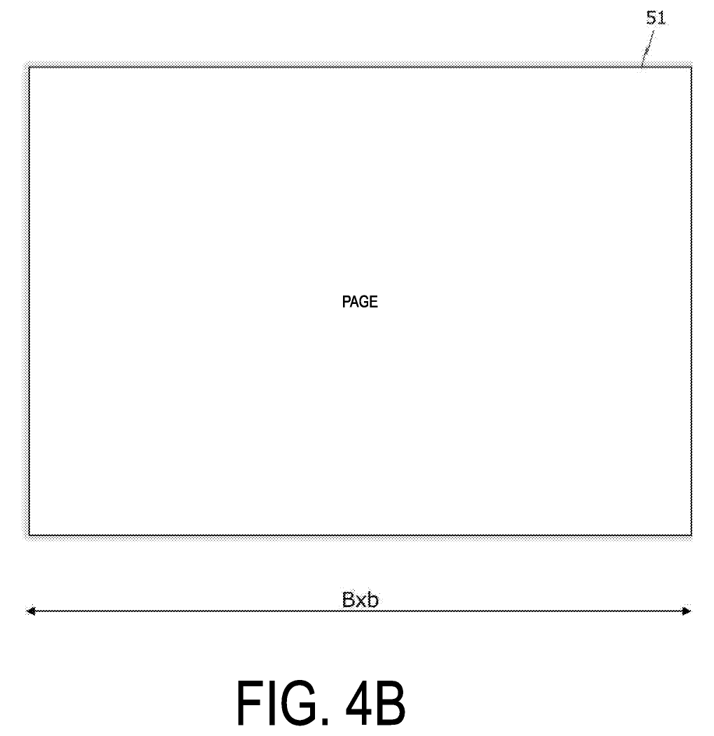

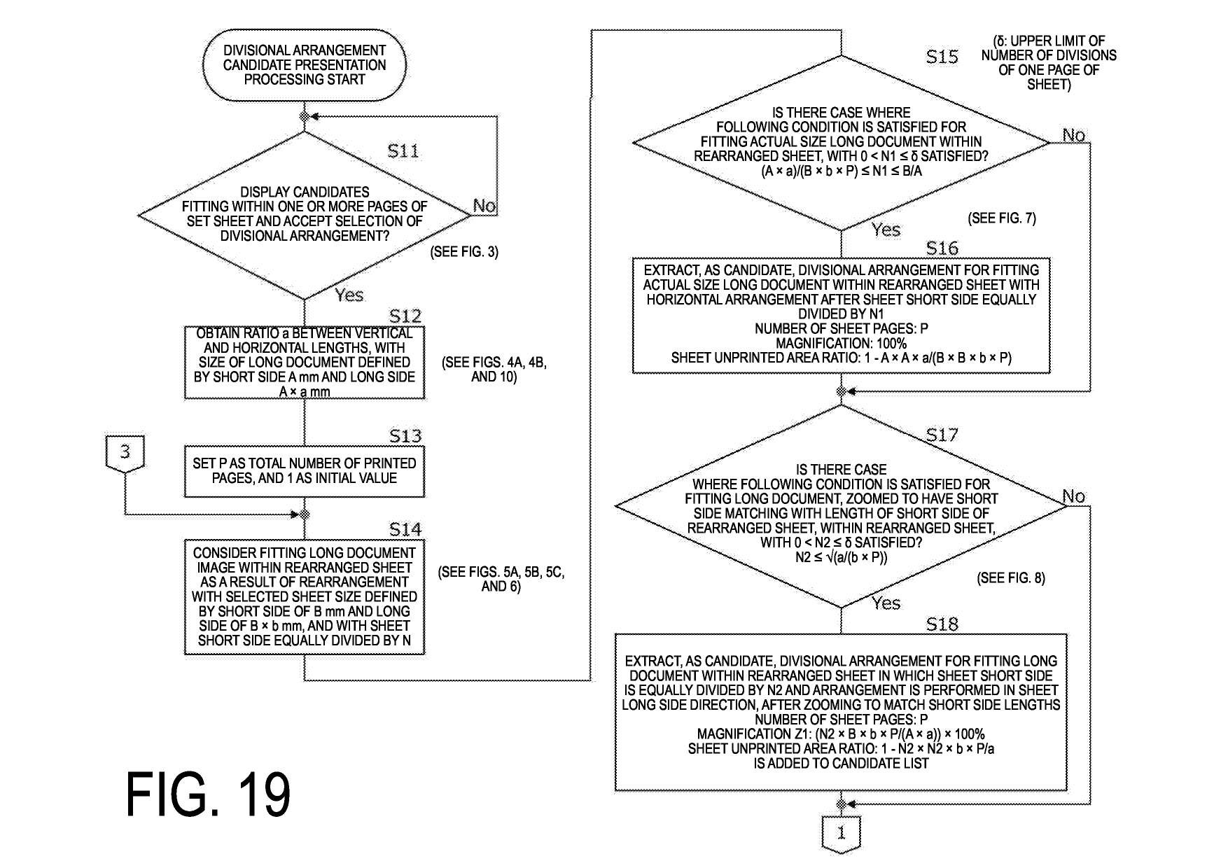

Next, processing of determining candidates for a divisional arrangement according to the setting of the page setting screen 32 and presenting the candidates to the user will be described. FIGS. 4A to 18 are explanatory diagrams for explaining the concept of the divisional arrangement according to the present disclosure. FIGS. 19 to 22 are flowcharts illustrating an example of processing in which the image processor 12 determines candidates for the divisional arrangement according to the present disclosure.

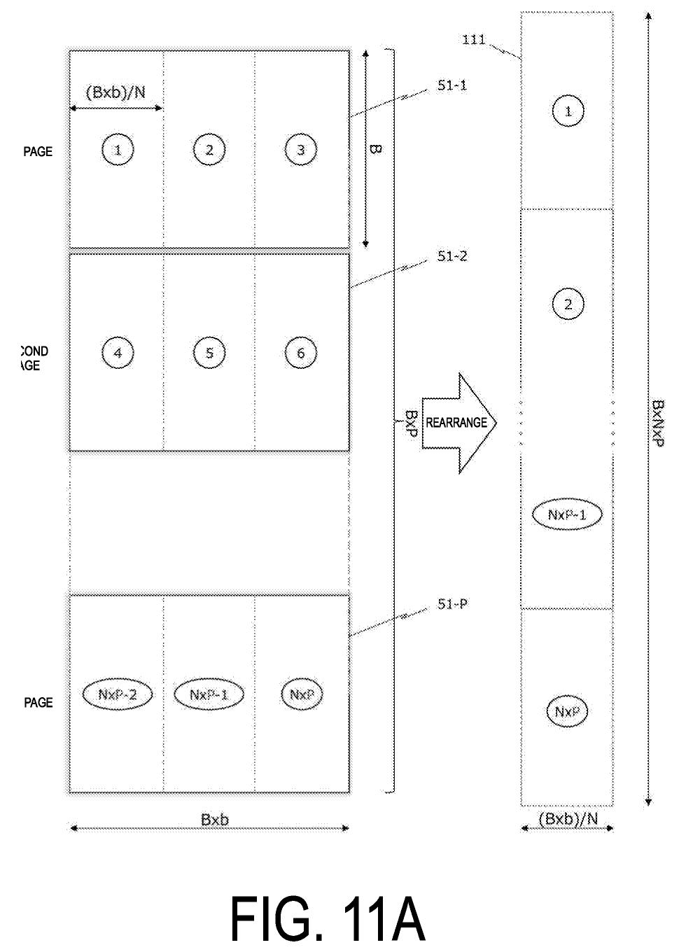

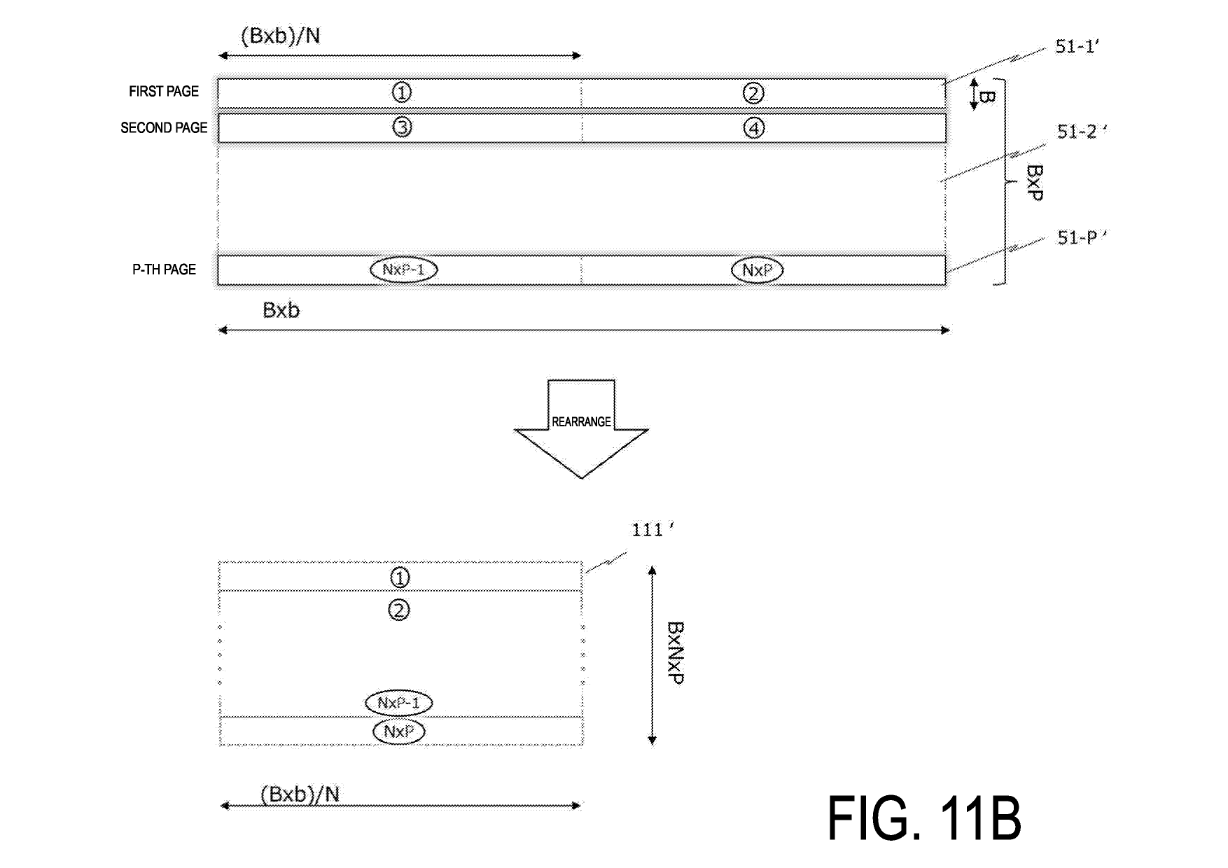

First, the concept of the divisional arrangement according to the present disclosure will be described with reference to FIGS. 4A to 18. FIG. 4A is an explanatory diagram illustrating an example of a long image document according to the present disclosure. A long document image 41 illustrated in FIG. 4A is a horizontally long document, and has the short side (the side extending in the vertical direction) with a length A and the long side (the side extending in the horizontal direction) with a length A × a. The symbol a is a ratio of the length of the long side to the length of the short side, and satisfies a > 1. However, this should not be construed in a limiting sense, and the image may be a vertically long document image 101 as illustrated in FIG. 1. They may be referred to as the long document image 41 without distinction. Also in the case of the vertically long image, the length of the short side (the side extending in the horizontal direction) is defined as A, and the length of the long side (the side extending in the vertical direction) is defined as A × a. Also in the case of the vertically long image, a > 1 is satisfied. That is, the image satisfies a ≥ 1. FIG. 4B is an explanatory diagram illustrating an example of a sheet, that is, an output size of a rectangle, according to the present disclosure. An output size 51 illustrated in FIG. 4B is horizontally long, and has the side extending in the vertical direction (short side) with a length B and the side extending in the horizontal direction (long side) with a length B × b. The symbol b is a ratio of the length of the long side (the side extending in the horizontal direction) to the length of the short side (the side extending in the vertical direction), and satisfies b > 1 in the example in FIG. 4B. The output size may be vertically long. Still, since such a vertically long output size will be horizontally long upon being rotated by 90°, and since the division of the long side of the horizontally long sheet is also considered as illustrated in FIGS. 11A and 11B and subsequent drawings to provide the same result, only an example in which the sheet is based on the horizontally long direction will be described. Although the description on the vertically long sheet is omitted, similarly, the short side length is defined as B and the long side length is defined as B × b. That is, the sheet satisfies b ≥ 1.

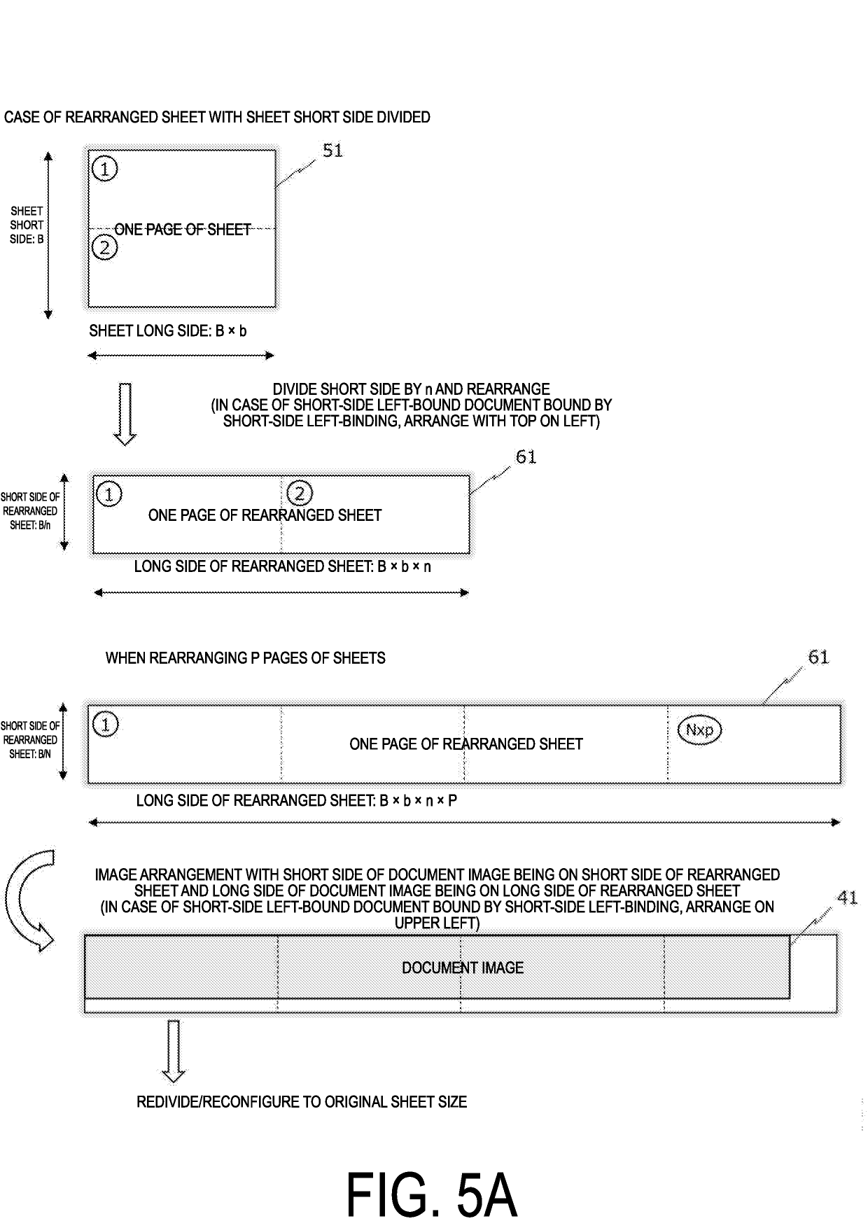

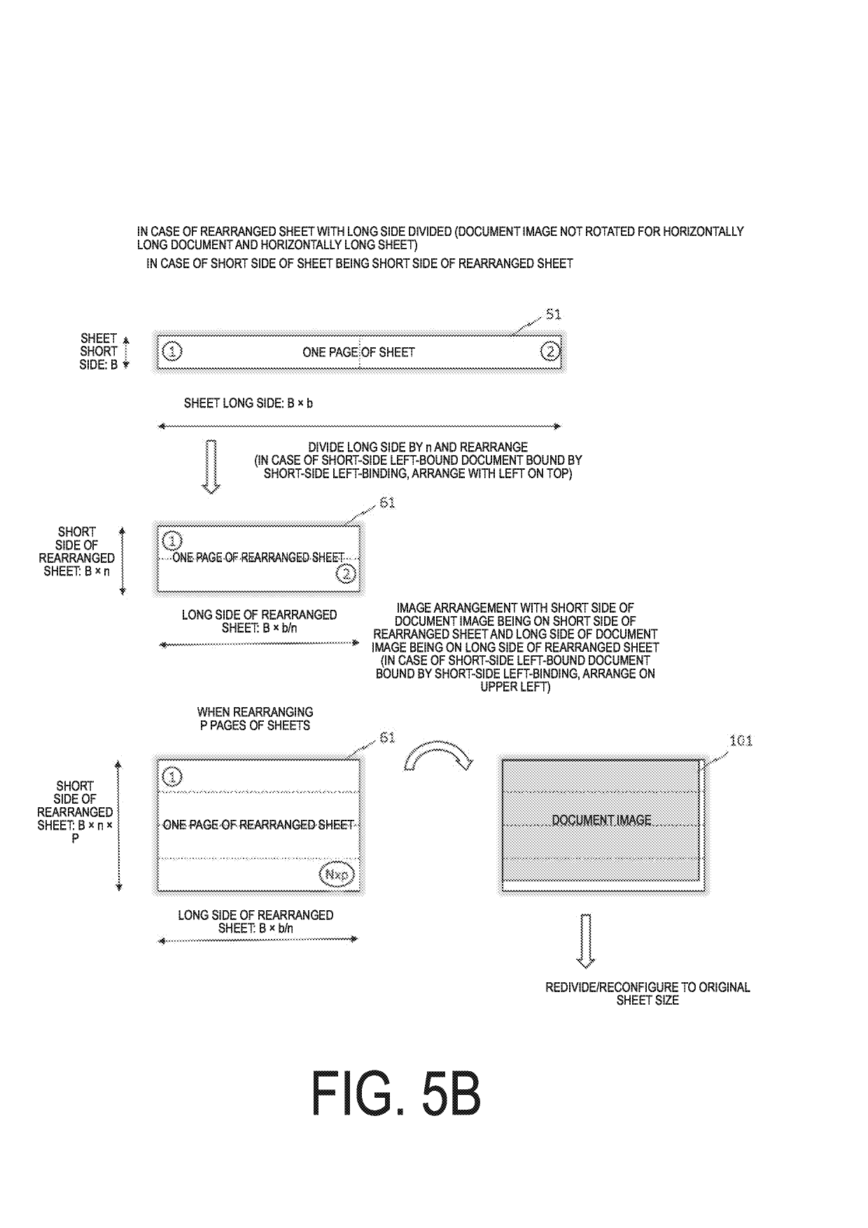

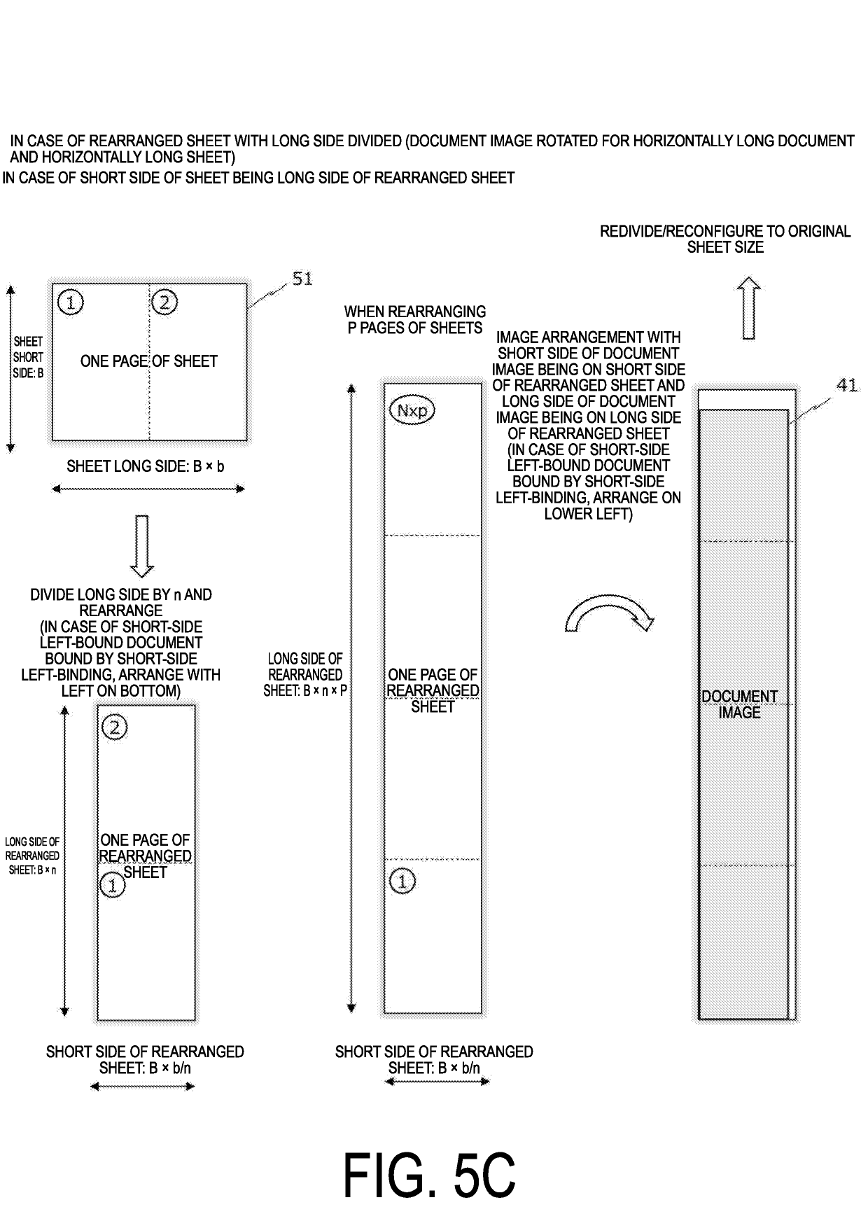

FIGS. 5A to 5C are explanatory diagrams illustrating a basic procedure of the divisional arrangement and output of an image according to this embodiment. FIG. 5A is a diagram schematically illustrating a procedure for determining whether a long document image fits within a rearranged sheet obtained by dividing the short side of a sheet of the output size and performing rearrangement. FIG. 5B is a diagram schematically illustrating a procedure for determining whether a long document image fits within a rearranged sheet obtained by dividing the long side of a sheet of the output size and performing rearrangement. FIG. 5C is a diagram schematically illustrating a procedure for determining whether a long document image rotated by 90° fits within a rearranged sheet obtained by dividing the long side of a sheet of the output size and performing rearrangement.

As illustrated in FIG. 5A, when it is determined whether a long document image can fit within a rearranged sheet obtained by dividing the short side of a sheet of the output size and performing rearrangement, a rearranged sheet 61 is obtained by dividing the short side of the output size 51 by n and linearly arranging the divided sheet pieces in the direction of the long side. When a sheet of an output size of a plurality of pages is examined, the rearranged sheet 61 is obtained by linearly arranging the pages in the direction of the long side. In the case of the horizontally long document image 41 illustrated in FIG. 4A, it is determined whether the document image can fit within the rearranged sheet 61 illustrated in FIG. 5A.

As illustrated in FIG. 5B, when it is determined whether a long document image can fit within a rearranged sheet obtained by dividing the long side of a sheet of the output size and performing rearrangement, the rearranged sheet 61 is obtained by dividing the long side of the output size 51 by n and linearly arranging the divided sheet pieces in the direction of the short side. When a sheet of an output size of a plurality of pages is examined, the rearranged sheet 61 is obtained by linearly arranging the pages in the direction of the short side. In the case of the vertically long document image 101 illustrated in FIG. 4A, it is determined whether the document image can fit within the rearranged sheet 61 illustrated in FIG. 5B.

As illustrated in FIG. 5C, whether the long document image rotated by 90° can fit within the rearranged sheet may be determined. FIG. 5C is an example of determining whether a long document image rotated by 90° fits within a rearranged sheet obtained by dividing the long side of a sheet of the output size and performing rearrangement. Also in this case, the rearranged sheet 61 is obtained by dividing the long side of the output size 51 by n and linearly arranging the divided sheet pieces in the direction of the short side, as in FIG. 5B. When a sheet of an output size of a plurality of pages is examined, the rearranged sheet 61 is obtained by linearly arranging the pages in the direction of the short side. In the case of the horizontally long document image 41 illustrated in FIG. 4A, it is determined whether the long document image 41 rotated by 90° fits within the rearranged sheet 61 illustrated in FIG. 5C.

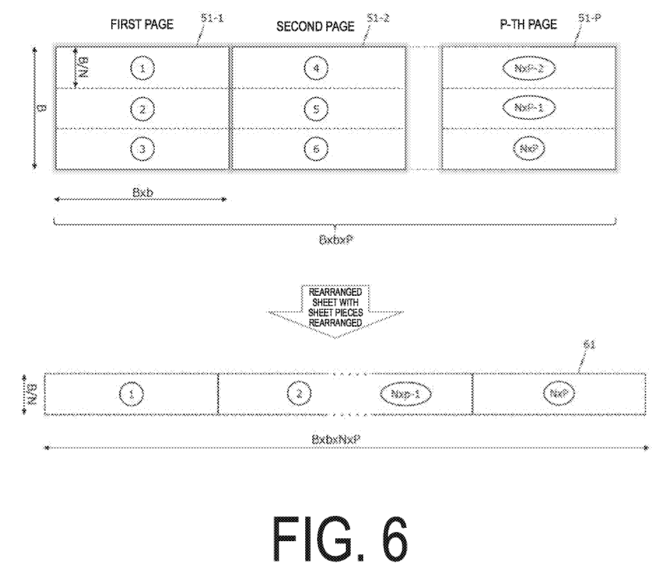

The details will be described below. FIG. 6 is an explanatory diagram illustrating an example of a rearranged sheet (a case of dividing the short side of the output size sheet as illustrated in FIG. 5A) according to the present disclosure. In FIG. 6, above the white arrow, output sizes 51-1 to 51-P of P pages are arranged in the horizontal direction, and each page is illustrated in a state in which the short side is equally divided by N. N is a natural number. One of the output sizes obtained by equally dividing each page by N is a sheet piece, and the length of a side extending in the vertical direction of the sheet piece is B/N, and the length of a side extending in the horizontal direction is B × b. Below the white arrow, the rearranged sheet 61 is illustrated in which the N × P sheet pieces in the upper part are linearly arranged in the horizontal direction. In this case, the order of rearranging the sheet pieces is indicated by circled numbers. That is, the sheet pieces arranged in the order from the top to the bottom in an original page are arranged in the order from left to right in the rearranged sheet 61. The sheet pieces arranged in the order from top to bottom in the page adjacent to the original page are also rearranged in ascending order from left to right. The length of the side extending in the vertical direction of the rearranged sheet 61 is B/N, and the length of the side extending in the horizontal direction is B × b × N × P. The processing of obtaining the size of the rearranged sheet 61 corresponds to the function of the rearrangement output size calculator 12S in the present disclosure. In the example of FIG. 6, since the short-side left-bound document is bound by short-side left-binding, the rearrangement of a "И" type is employed on the premise that the document image and the rearranged sheet are arranged with their upper left sides matching, while improving the readability on one page of sheet (simultaneous readability of a plurality of continuous sheet pieces). While the arrangement and rearrangement are performed in consideration of matching the writing start position of the document image and the reading direction of the printed matter, the rearrangement order may be directly designated separately, such as the "И" type of downward arrangement from upper left with a subsequent row shifting rightward, an "N" type of downward arrangement from upper right with a subsequent row shifting leftward, a "Z" type of rightward arrangement from upper left with a subsequent row shifting downward, and the like. The rearrangement of another type may be employed, such as an arrangement at the center of the rearranged sheet.

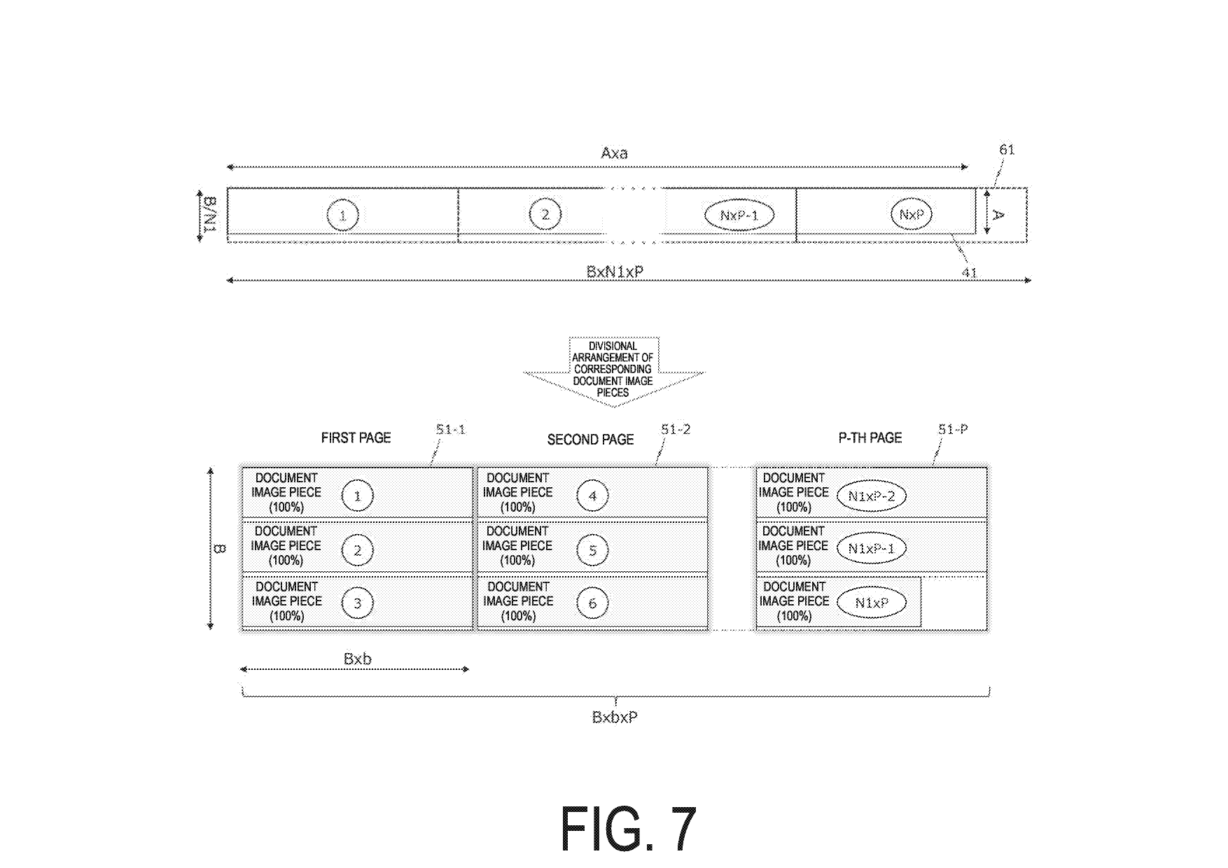

FIGS. 7 to 9 illustrate how the long document image 41 illustrated in FIG. 4A is superimposed on the rearranged sheet 61 illustrated in FIG. 6, the division to obtain the document image pieces is determined, and rearrangement is performed. Document image pieces can be determined to be obtained by dividing the long document image 41 superimposed on the rearranged sheet 61 at positions corresponding to the respective sheet pieces in the longitudinal direction (horizontal direction). The process of dividing the long document image 41 at the positions corresponding to the respective sheet pieces corresponds to the function of the actual size document divider 12D in the present disclosure. Then, the document image pieces are illustrated in a state in which the document image pieces are rearranged in the output sizes 51-1 to 51-P of the P pages corresponding to the arrangement of the original pages illustrated in the upper part of FIG. 6. The function of determining the image in which the document image pieces are rearranged as the candidate for the divisional arrangement that is outputtable corresponds to the function of the divisional arrangement determiner 12L in the present disclosure. As a method of superimposing the long document image 41 on the rearranged sheet 61, in the example illustrated in FIG. 7, the long document image 41 of the actual size is superimposed on the rearranged sheet 61. However, the example illustrated in FIG. 7 can be applied to a case where the long document image 41 of the actual size fits within the rearranged sheet 61. In other words, the example is applicable when the long document image 41 is equal to or shorter than the rearranged sheet 61 in both the vertical and horizontal directions.

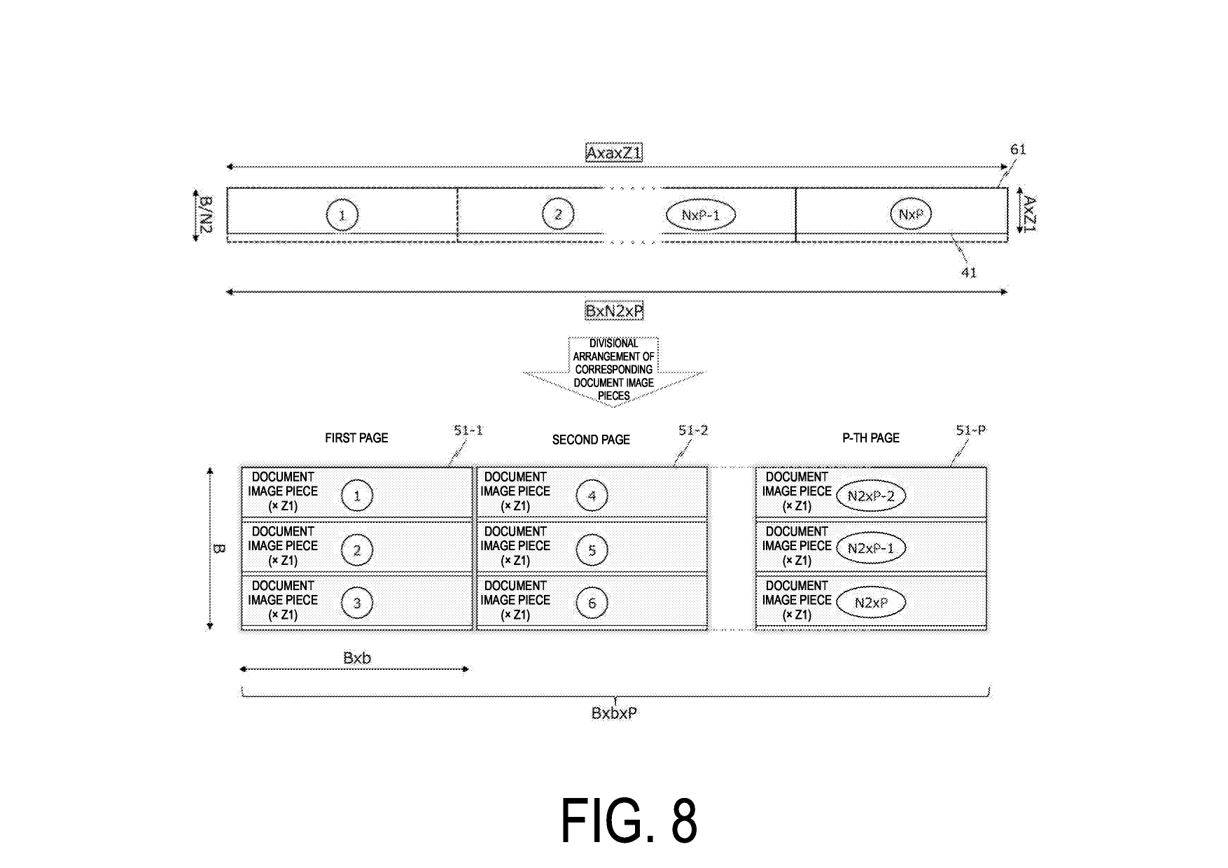

In the example illustrated in FIG. 8, the length of the side of the long document image 41 extending in the horizontal direction is zoomed (scaled) at a magnification Z1 so as to match the length of the side of the rearranged sheet 61 extending in the horizontal direction. The zoomed long document image has the side extending in the horizontal direction with a length A × a × Z1 and the side extending in the vertical direction with a length A × Z1. The process of dividing the zoomed long document image 41 at the positions corresponding to the respective sheet pieces corresponds to the function of the zoom document divider 12Z in the present disclosure. The function of determining the image in which the document image pieces are rearranged as the candidate for the divisional arrangement that is outputtable corresponds to the function of the divisional arrangement determiner 12L in the present disclosure. However, the example illustrated in FIG. 8 can be applied to a case where the size of the zoomed long document image 41 in the vertical direction fits within the rearranged sheet 61. In other words, the example is applicable when the long document image 41 has an aspect ratio that is thinner and longer than the rearranged sheet 61.

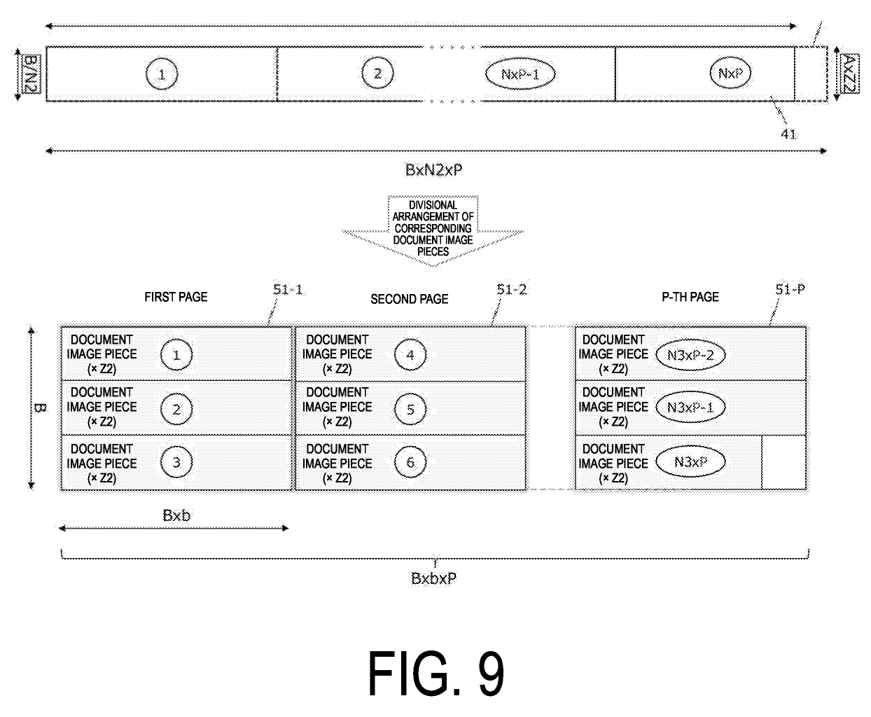

In the example illustrated in FIG. 9, the length of the side of the long document image 41 extending in the vertical direction is zoomed at a magnification Z2 so as to match the length of the side of the rearranged sheet 61 extending in the vertical direction. The zoomed long document image has the side extending in the vertical direction with a length A × Z2 and the side extending in the horizontal direction with a length A × a × Z2. The process of dividing the zoomed long document image 41 at the positions corresponding to the respective sheet pieces corresponds to the function of the zoom document divider 12Z in the present disclosure. The function of determining the image in which the document image pieces are rearranged as the candidate for the divisional arrangement that is outputtable corresponds to the function of the divisional arrangement determiner 12L in the present disclosure. However, the example illustrated in FIG. 8 can be applied to a case where the size of the zoomed long document image 41 in the horizontal direction fits within the rearranged sheet 61. In other words, the example is applicable when the long document image 41 has an aspect ratio that is thicker than the rearranged sheet 61.

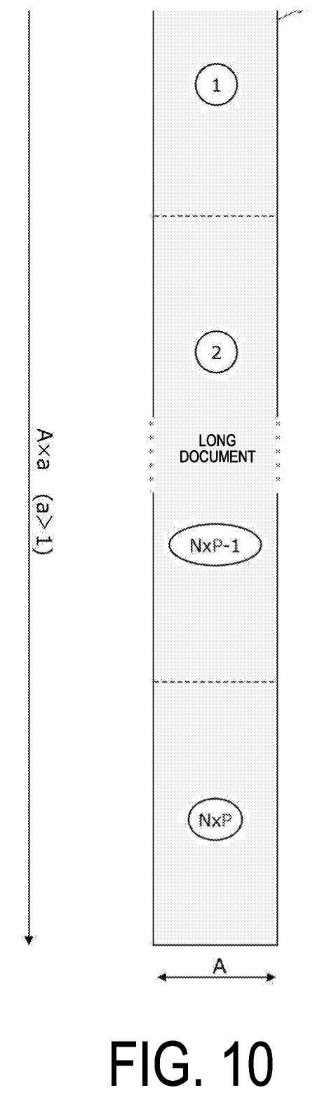

Next, FIGS. 10 to 18 will be described. FIG. 10 is an explanatory diagram illustrating an example of a case where the long image document according to the present disclosure is vertically long. The long document image 101 illustrated in FIG. 10 has the side extending in the vertical direction (long side) with a length A × a and the side extending in the horizontal direction (short side) with a length A. That is, a > 1 always holds.

FIG. 11A is an explanatory diagram illustrating an example of the rearranged sheet according to the present disclosure (in a case where the output size sheet long side is divided, and the short side of the sheet is on the long side of the rearranged sheet as in FIG. 5C). In FIG. 11A, on the left side of the white arrow, the output sizes 51-1 to 51-P of the P pages are arranged in the vertical direction, and each page is illustrated in a state where the long side is equally divided by N. N is a natural number. One of the output sizes obtained by equally dividing each page by N is a sheet piece, and the length of a side extending in the vertical direction of the sheet piece is B, and the length of a side extending in the horizontal direction is B × b/N. On the right side of the white arrow, a rearranged sheet 111 is illustrated in which the N × P sheet pieces in the upper part are linearly arranged in the vertical direction. In this case, the order of rearranging the sheet pieces is indicated by circled numbers. That is, the sheet pieces arranged in the order from left to right in an original page are arranged in the order from top to bottom in the rearranged sheet 111. The sheet pieces arranged in the order from right to left in the page adjacent to the original page are also rearranged in ascending order from top to bottom. The length of the side extending in the vertical direction of the rearranged sheet 111 is B × N × P, and the length of the side extending in the horizontal direction is B × b/N. The processing of obtaining the size of the rearranged sheet 111 corresponds to the function of the rearrangement output size calculator 12S in the present disclosure. In the example of FIGS. 10, 11A, and 11B, since the vertically long short-side top-bound document is bound by short-side left-binding, the rearrangement of the "Z" type is employed on the premise that the document image and the rearranged sheet are arranged with their upper left sides matching, while improving the readability on one page of sheet (simultaneous readability of a plurality of continuous sheet pieces). While the arrangement and rearrangement are performed in consideration of matching the writing start position of the document image and the reading direction of the printed matter, the rearrangement order and arrangement method may be designated separately. Further, as illustrated in FIG. 5C, when the document image is long in the horizontal direction and the short-side left-bound document is bound by the short-side left-binding, the order of rearranging the sheet pieces is different from that in FIG. 11A. That is, the sheet pieces arranged in the order from left to right in the original page are arranged in the order from bottom to top in the rearranged sheet. The rearrangement of the "Z" type on is employed on the premise that the arrangement is performed in such a manner that the lower left of the document image rotated counterclockwise by 90 degrees (the upper left of the original document image) and the lower left of the rearranged sheet match. While the arrangement and rearrangement are performed in consideration of matching the writing start position of the document image and the reading direction of the printed matter, the rearrangement order and arrangement method may be designated separately.

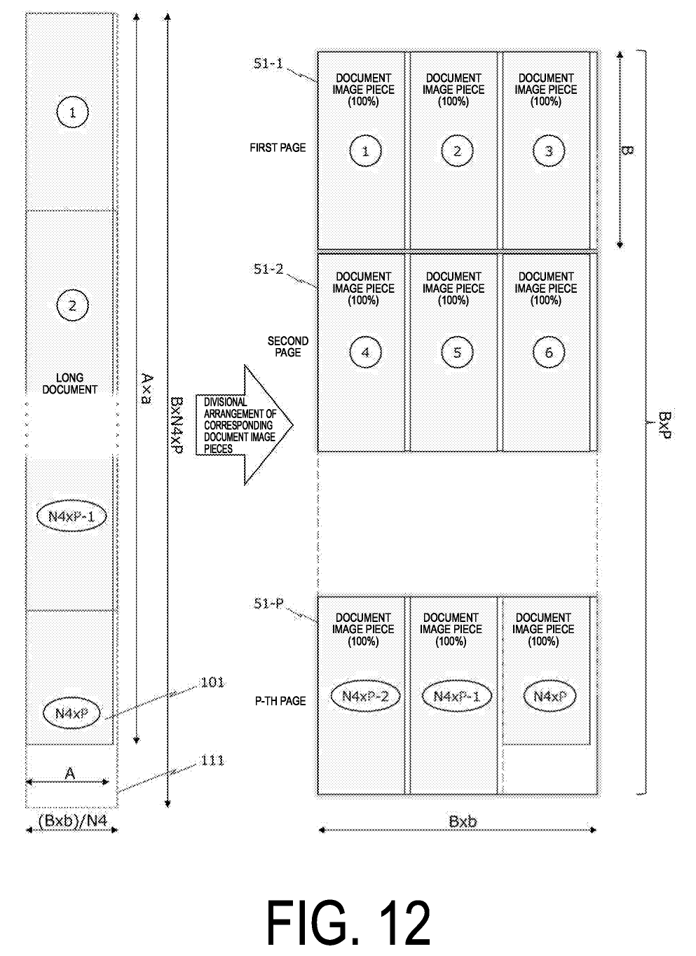

FIGS. 12 to 14 illustrate how the long document image 101 illustrated in FIG. 10 is superimposed on the rearranged sheet 111 illustrated in FIG. 11A, the division to obtain the document image pieces is determined, and rearrangement is performed. Document image pieces can be determined to be obtained by dividing the long document image 101 superimposed on the rearranged sheet 111 at positions corresponding to the respective sheet pieces in the longitudinal direction (vertical direction). The process of dividing the long document image 41 at the positions corresponding to the respective sheet pieces corresponds to the function of the actual size document divider 12D in the present disclosure. Then, the document image pieces are illustrated in a state in which the document image pieces are rearranged in the output sizes 51-1 to 51-P of the P pages corresponding to the arrangement of the original pages illustrated in the left part of FIG. 11A. The function of determining the image in which the document image pieces are rearranged as the candidate for the divisional arrangement that is outputtable corresponds to the function of the divisional arrangement determiner 12L in the present disclosure. As a method of superimposing the long document image 101 on the rearranged sheet 111, in the example illustrated in FIG. 12, the long document image 101 of the actual size is superimposed on the rearranged sheet 111. However, the example illustrated in FIG. 12 can be applied to a case where the long document image 101 of the actual size fits within the rearranged sheet 111. In other words, the example is applicable when the long document image 101 is equal to or shorter than the rearranged sheet 111 in both the vertical and horizontal directions.

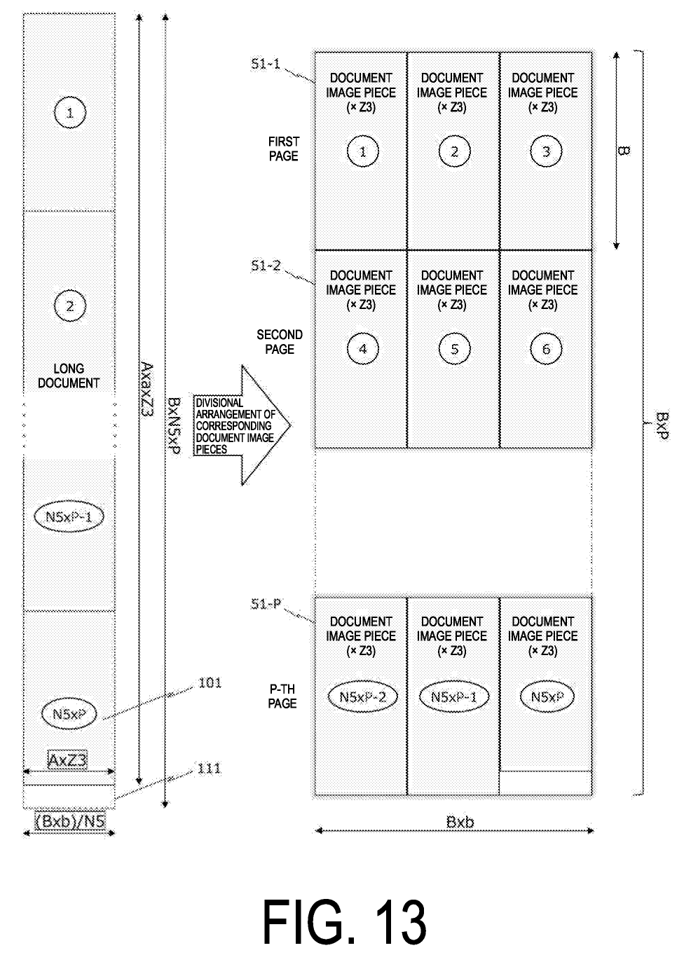

In the example illustrated in FIG. 13, the length of the side of the long document image 101 extending in the horizontal direction is zoomed at a magnification Z3 so as to match the length of the side of the rearranged sheet 111 extending in the horizontal direction. The zoomed long document image has the side extending in the vertical direction with a length A × a × Z3 and the side extending in the horizontal direction with a length A × Z3. The process of dividing the zoomed long document image 41 at the positions corresponding to the respective sheet pieces corresponds to the function of the zoom document divider 12Z in the present disclosure. The function of determining the image in which the document image pieces are rearranged as the candidate for the divisional arrangement that is outputtable corresponds to the function of the divisional arrangement determiner 12L in the present disclosure. However, the example illustrated in FIG. 13 can be applied to a case where the size of the zoomed long document image 101 in the vertical direction fits within the rearranged sheet 111. In other words, the example is applicable when the long document image 101 has an aspect ratio that is thicker than the rearranged sheet 111.

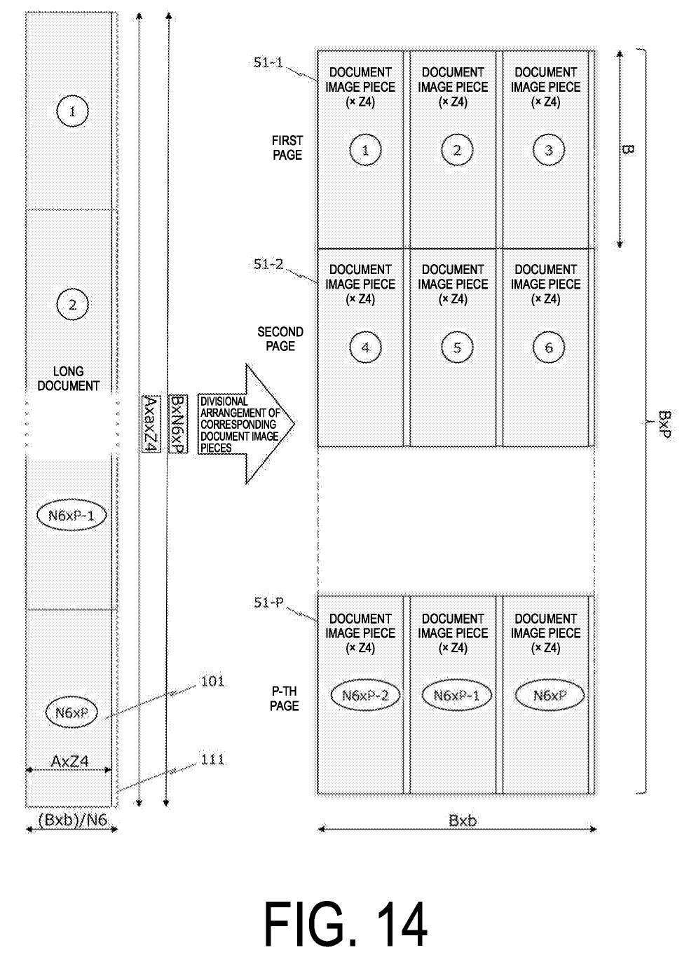

In the example illustrated in FIG. 14, the length of the side of the long document image 101 extending in the vertical direction is zoomed at a magnification Z4 so as to match the length of the side of the rearranged sheet 111 extending in the vertical direction. The zoomed long document image has the side extending in the horizontal direction with a length A × Z4 and the side extending in the vertical direction with a length A × a × Z4. The process of dividing the zoomed long document image 41 at the positions corresponding to the respective sheet pieces corresponds to the function of the zoom document divider 12Z in the present disclosure. The function of determining the image in which the document image pieces are rearranged as the candidate for the divisional arrangement that is outputtable corresponds to the function of the divisional arrangement determiner 12L in the present disclosure. However, the example illustrated in FIG. 14 can be applied to a case where the size of the zoomed long document image 101 in the horizontal direction fits within the rearranged sheet 111. In other words, the example is applicable when the long document image 101 has an aspect ratio that is thinner and longer than the rearranged sheet 111.

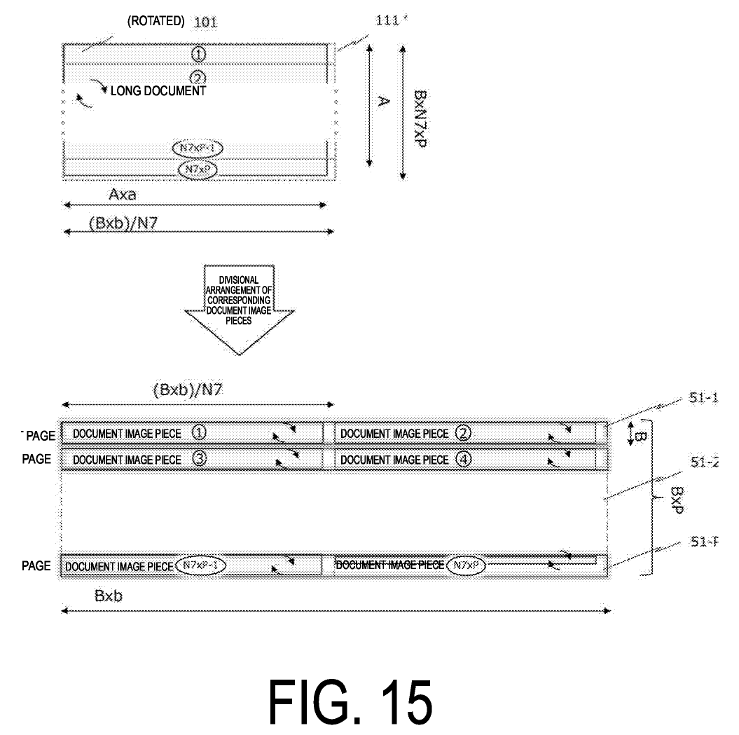

In the case of sheet pieces obtained by equally dividing the long side of the output size by N as illustrated in FIG. 11B (and FIG. 5B), the length B × b/N of the side, obtained by the N equal division, may be longer than the length B of the other side. Then, the length B × b/N of the side extending in the horizontal direction of a rearranged sheet 111' in which the sheet pieces are arranged vertically may be longer than the length B × N × P of the side extending in the vertical direction. That is, the rearranged sheet 111' may be horizontally long. In this case, in order to superimpose the vertically long document image 101 on the horizontally long rearranged sheet 111', the long document image 101 should be rotated by 90° so as to match the vertical and horizontal sizes thereof with those of the rearranged sheet 111'. FIGS. 15 to 17 illustrate how the long document image 101 illustrated in FIG. 10 is rotated by 90° and superimposed on the rearranged sheet 111' illustrated in FIG. 11B, the division to obtain the document image pieces is determined, and rearrangement is performed. While a specific aspect differs from that in the example illustrated in FIG. 5B with a different orientation of the document, the point that it is determined whether the long document image fits within the rearranged sheet after allowing the rotation is common. Document image pieces can be determined to be obtained by dividing the long document image 101 superimposed on the rearranged sheet 111' at positions corresponding to the respective sheet pieces. The process of dividing the long document image 41 at the positions corresponding to the respective sheet pieces corresponds to the function of the actual size document divider 12D in the present disclosure. Then, the document image pieces are illustrated in a state in which the document image pieces are rearranged in output sizes 51-1' to 51-P' of the P pages corresponding to the arrangement of the original pages illustrated in the left part of FIG. 11B. The function of determining the image in which the document image pieces are rearranged as the candidate for the divisional arrangement that is outputtable corresponds to the function of the divisional arrangement determiner 12L in the present disclosure. As a method of superimposing the long document image 101 on the rearranged sheet 111', in the example illustrated in FIG. 15, the long document image 101 of the actual size rotated by 90° is superimposed on the rearranged sheet 111'. However, the example illustrated in FIG. 15 can be applied to a case where the long document image 101 of the actual size fits within the rearranged sheet 111. In other words, the example is applicable when the long document image 101 rotated by 90° is equal to or shorter than the rearranged sheet 111' in both the vertical and horizontal directions.

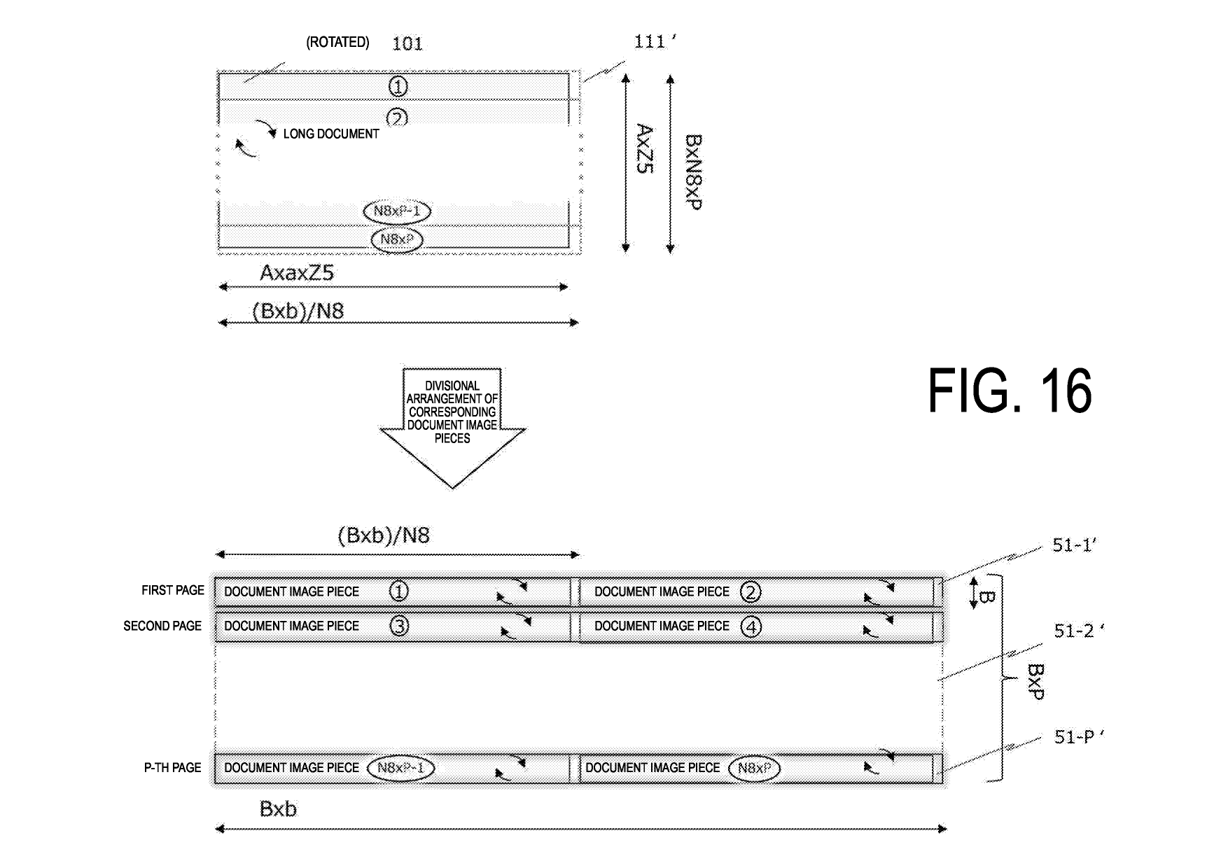

In the example illustrated in FIG. 16, the long document image 101 rotated by 90° is zoomed at a magnification Z5 to have the short side direction length matching the short side direction length of the rearranged sheet 111'. The zoomed long document image has the short side direction length of A × a × Z5, and the long side direction length of A × Z5. The process of dividing the zoomed long document image 41 at the positions corresponding to the respective sheet pieces corresponds to the function of the zoom document divider 12Z in the present disclosure. The function of determining the image in which the document image pieces are rearranged as the candidate for the divisional arrangement that is outputtable corresponds to the function of the divisional arrangement determiner 12L in the present disclosure. However, the example illustrated in FIG. 16 can be applied to a case where the size of the zoomed long document image 101 rotated by 90° in the horizontal direction fits within the rearranged sheet 111'. In other words, the example is applicable when the long document image 101 rotated by 90° has an aspect ratio that is thinner and longer than the rearranged sheet 111'.

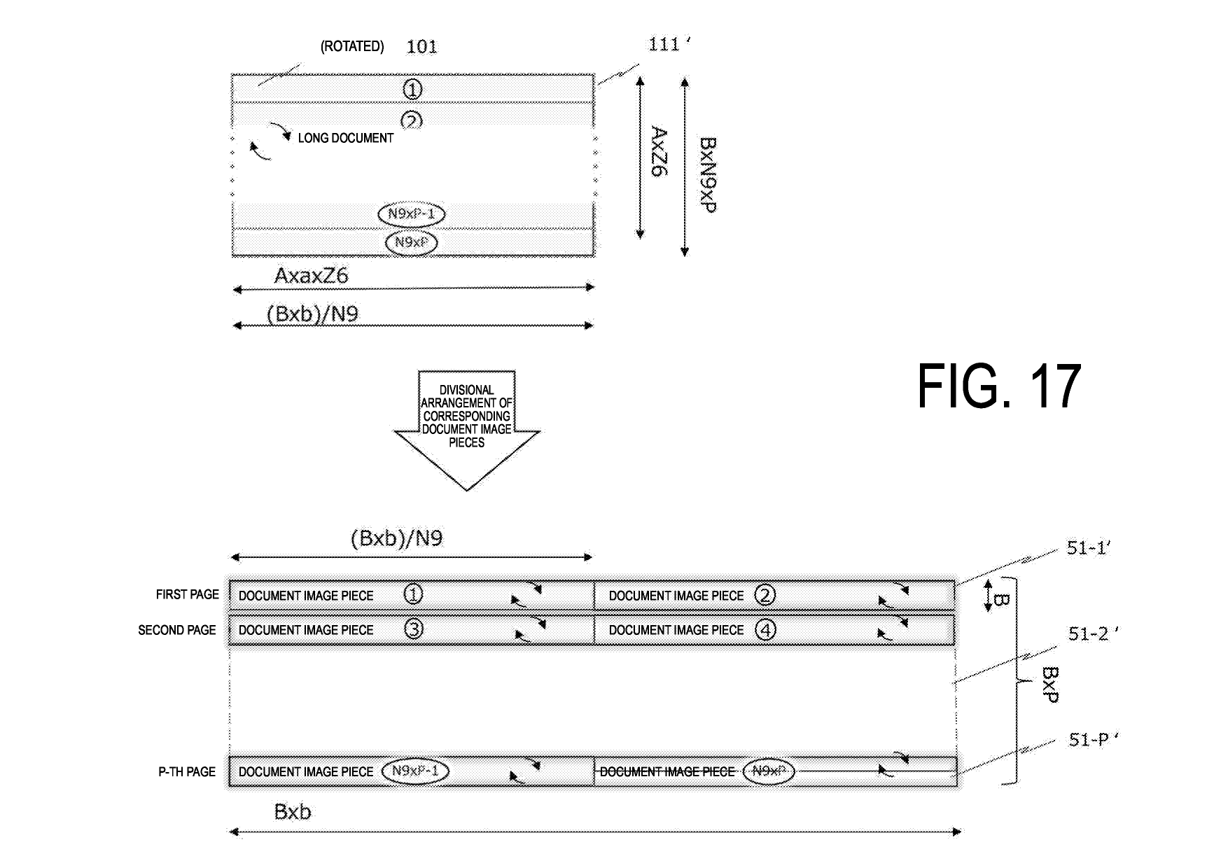

In the example illustrated in FIG. 17, the long document image 101 rotated by 90° is zoomed at a magnification Z6 to have the long side direction length matching the long side direction length of the rearranged sheet 111'. The zoomed long document image has the long side direction length of A × Z6, and the short side direction length of A × a × Z6. The process of dividing the zoomed long document image 41 at the positions corresponding to the respective sheet pieces corresponds to the function of the zoom document divider 12Z in the present disclosure. The function of determining the image in which the document image pieces are rearranged as the candidate for the divisional arrangement that is outputtable corresponds to the function of the divisional arrangement determiner 12L in the present disclosure. However, the example illustrated in FIG. 17 can be applied to a case where the size of the zoomed long document image 101 rotated by 90° in the vertical direction fits within the rearranged sheet 111'. In other words, the example is applicable when the long document image 101 rotated by 90° has an aspect ratio that is thicker than the rearranged sheet 111'.

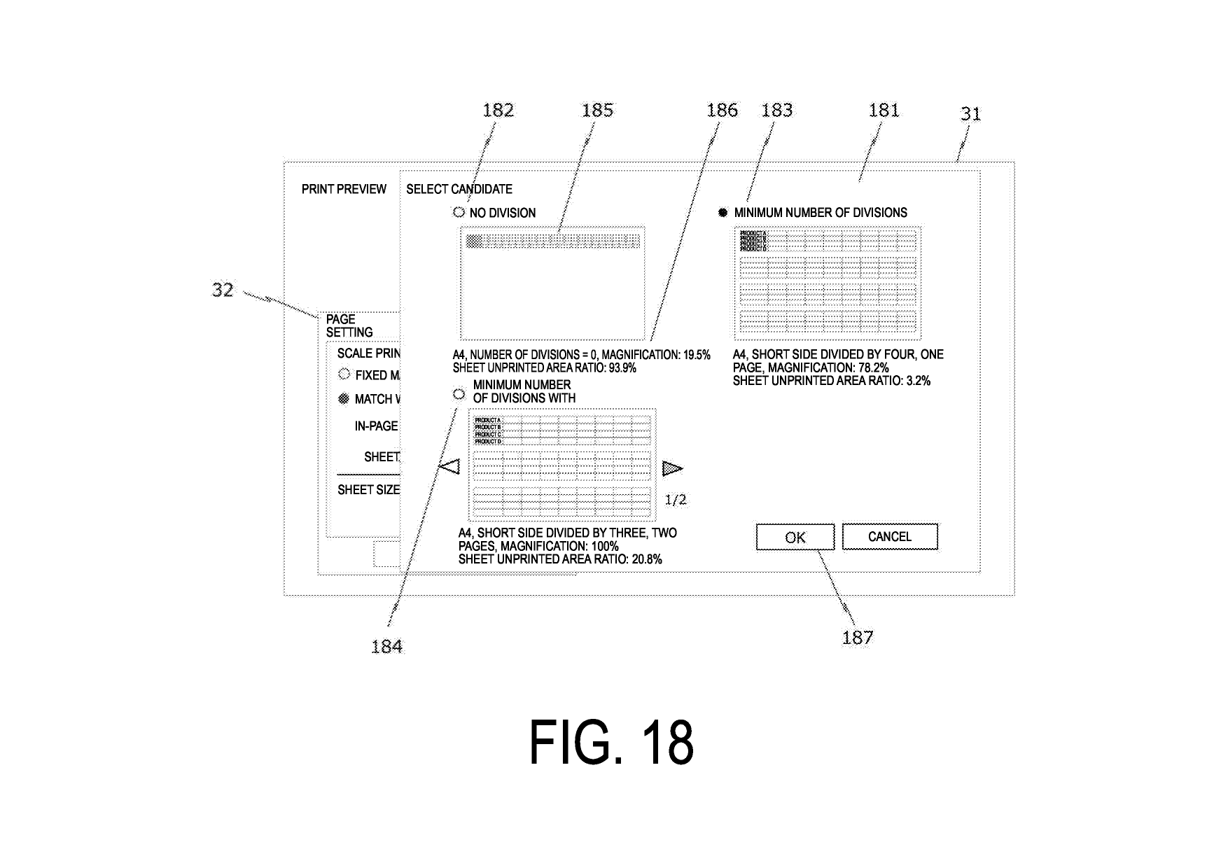

FIG. 18 is an explanatory diagram illustrating an example in which the image processor 12 determines a feasible one of the divisional arrangements illustrated in FIGS. 7 to 9 and FIGS. 12 to 17 within the range of the conditions set on the page setting screen 32 illustrated in FIG. 3, and presents a suitable candidate for the predetermined condition to the user. In the example illustrated in FIG. 18, a candidate selection screen 181 is pop-up displayed on a screen that is the same as that in FIG. 3. On the candidate selection screen 181, a thumbnail 185 and a condition/index 186 of output candidates suitable for each of three priority conditions 182 to 184 are displayed and presented to the user. The first priority condition 182 is "no division". The second priority condition 183 is a condition that minimizes the number of divisions. The third priority condition 184 is a condition that minimizes the number of divisions for the actual size.

These priority conditions may be selectable in advance by the user on a selection screen (not illustrated). Further, for example, a condition that minimizes an unprinted area ratio may be set as a priority condition. Alternatively, a condition for minimizing the number of pages may be settable. Further, in a case where the long document image 41 includes characters and the image processor 12 can recognize the size of the characters using a technique such as character recognition, a priority condition making the size of the characters fall within a predetermined range may be settable. The priority condition in this case is related to the upper limit value of the number of divisions N and the lower limit value of the number of pages P, and contributes to selection of the number of divisions N and the number of pages P suitable for the size of the characters on the document in a divisional arrangement. In this way, by setting a condition desired by the user as a priority condition, the user can easily select a divisional arrangement that can obtain a desired output.

As the condition/index 186, (1) the number of divisions, (2) which of the short side and the long side is equally divided, (3) the magnification of the long document image, and (4) the unprinted area ratio of the sheet, which is the ratio of the unprinted area (the portion that is not the long document image) in the rearranged sheet, are displayed according to the candidate divisional arrangement. In this way, the user can refer to the condition/index 186 displayed together with the thumbnail 185 for the candidate and select a candidate for the divisional arrangement with which the output has a reduced blank, for example. The condition/index 186 illustrated in FIG. 18 is an example, and should not be construed in a limiting sense. It can be regarded that (1) to (3) of the above-described condition/index 186 indicate the conditions of the divisional arrangement. In addition, (4) can be regarded as indicating an index of the divisional arrangement. Although omitted in the example of FIG. 18, the number of pages P may be further displayed as the condition/index 186. When an "OK" key 187 is operated, the display returns to FIG. 3, with "SELECTED" displayed for the item 34 about whether the method of adjustment to the sheet has been selected. Further, the gray-out of an "OK" key 39 at the lower end of the page setting screen 32 is released, whereby the key is displayed normally to be operable. Further, the preview screen 31 is changed to a preview according to the set condition. When the "OK" key 39 is operated to confirm the setting, the user who has confirmed the finish on the preview screen operates an operation button (not illustrated), whereby an image corresponding to the preview is output.

### Flowcharts

FIGS. 19 to 22 are flowcharts illustrating an example of a flow of processing in which the image processor 12 determines and presents a candidate for a divisional arrangement based on the setting illustrated in FIG. 3. The flow of the processing executed by the image processor 12 will be described with reference to these flowcharts. As illustrated in FIG. 3, the image processor 12 executes the following processing upon determining that the setting made by the user is received on the page setting screen 32 and that the setting is the setting of divisional arrangement for the long document (step S11 illustrated in FIG. 19). First, the corresponding values of A and a for the document are acquired with A (mm) being the size in the vertical direction and A × a being the size in the horizontal direction (step S12). FIG. 4A illustrates A and a. In the example in FIG. 3, it is assumed that the vertical and horizontal sizes of 760 mm × 65 mm are acquired from the number of pixels of the print area and the dpi (the number of pixels per inch) setting in the spreadsheet software used for printing. Then, the number of pages P to be output is set to 1 as an initial value (step S13). In the flowcharts in FIGS. 19 to 22, the upper limit value of the number of pages P is set in advance, and the divisional arrangements satisfying the condition of the number of pages equal to or less than the upper limit value are presented as candidates. Step S13 is for setting the initial value of the number of pages P equal to or less than the upper limit value.

Subsequently, the image processor 12 acquires the corresponding values of B and b for the sheet size 34 set on the page setting screen 37, that is, the output size, with B (mm) being the size of the short side and B × b being the size of the long side (step S14). FIG. 4B illustrates B and b. In the example in FIG. 3, the A4 size is selected as the sheet size 37. It is assumed that the image processor 12 has referred to a data table (not illustrated) in which the vertical and horizontal lengths of standard sizes are stored in advance, and acquired the vertical size of 210 mm and the horizontal size of 297 mm as data on an A4R size set to a tray.

Then, the image processor 12 determines whether the long document image 41 of the actual size as in the example illustrated in FIG. 7 fits within the rearranged sheet 61 under the set condition (step S15). Note that the determination is performed over the entirety of the range of the numbers of divisions N1 that are equal to or less than a predetermined upper limit value δ. That is, for all the numbers of divisions satisfying 0 < N1 ≤ δ, the numbers of divisions satisfying the condition are set as candidates. The upper limit value δ of the number of divisions may be a predetermined fixed value. Alternatively, the length may be determined according to the value of a indicating the aspect ratio of the long document image 41 or the size of the long document image 41, in other words, the values A and a. One of the conditions making the long document image 41 fit within the rearranged sheet 61 is that the long side of the long document image 41 is equal to or shorter than the long side of the rearranged sheet 61. This condition corresponds to the condition (A × a)/(B × b × P) ≤ N1 in step S15. Another condition is that the short side of the long document image 41 is equal to or shorter than the short side of the rearranged sheet 61. This condition corresponds to the condition N1 ≤ B/A in step S15. When the condition is satisfied (Yes in step S15), the divisional arrangement as in the example illustrated in FIG. 7 is set as a candidate (step S16). Such a condition related to the divisional arrangement condition/index 186 includes the short side of the sheet being equally divided by N1, the magnification corresponding to the actual size (100%), and the number of pages being P. The unprinted area ratio of the sheet as an indicator is 1 - A × A × a/(B × B × b × P). Then, the processing proceeds to the determination in step S17. On the other hand, when the condition is not satisfied (No in step S15), the processing proceeds to the determination in step S17 without adding the divisional arrangement related to the long document image 41 of the actual size to the candidates.

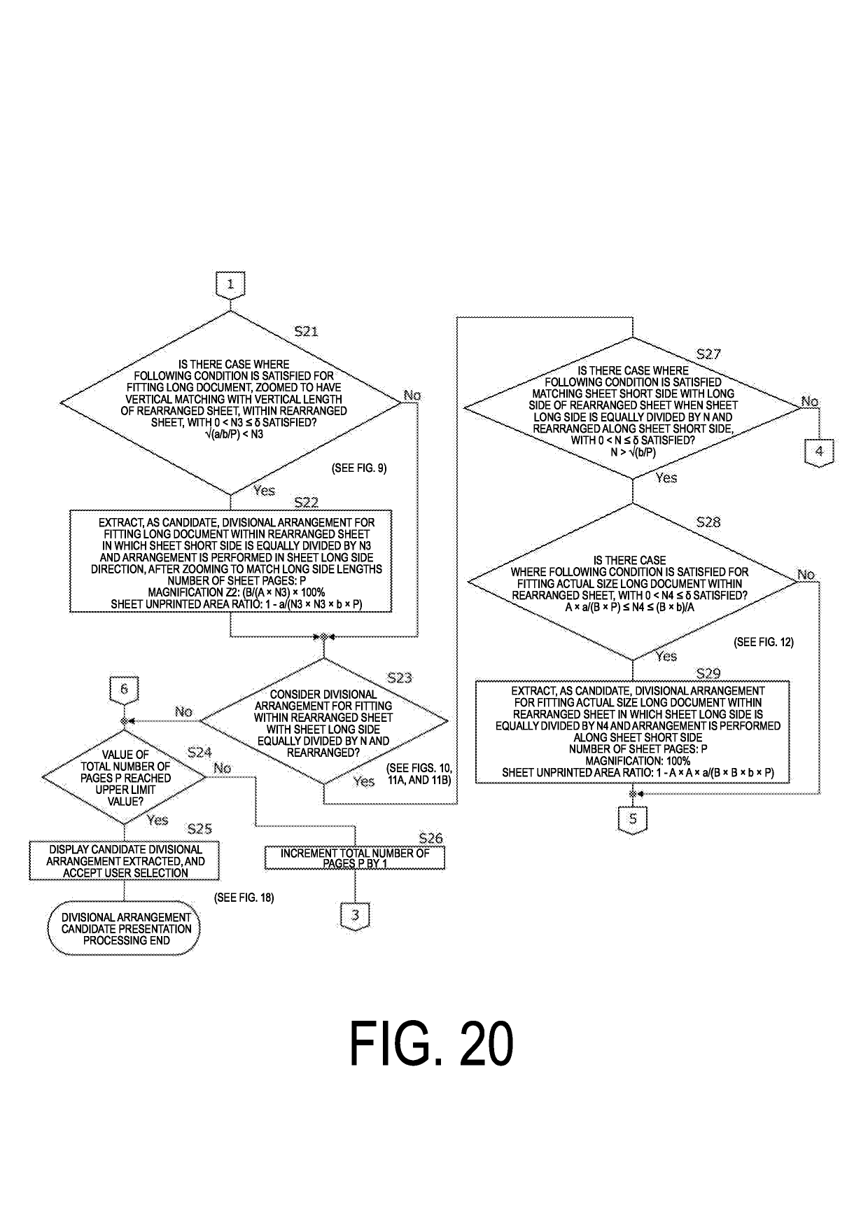

Then, the image processor 12 determines whether the long document image 41 zoomed for the long side matching as in the example illustrated in FIG. 8 fits within the rearranged sheet 61 under the set condition (step S17). Note that the determination is performed for all the numbers of divisions N2 that are equal to or less than the predetermined upper limit value δ, as in the determination in step S15. That is, for all the numbers of divisions satisfying 0 < N2 ≤ δ, the numbers of divisions satisfying the condition are set as candidates. From the condition for matching the long side size of the long document image 41 with the rearranged sheet 61, a zoom magnification Z1 = (N2 × B × b × P/(A × a)) × 100% is obtained for the long document image 41. The determination condition in step S17, i.e., N2 ≤ √(a/(b × P)), is derived from the value of the magnification Z1, and the condition that the short side size of the zoomed long document image 41 is smaller than the short side size of the rearranged sheet 61. When the condition is satisfied (Yes in step S17), the divisional arrangement as in the example illustrated in FIG. 8 is set as a candidate (step S18). Such a condition related to the divisional arrangement condition/index 186 includes the short side of the sheet being equally divided by N2, the magnification being Z1 described above, and the number of pages being P. The unprinted area ratio of the sheet as an indicator is 1 - N2 × N2 × b × P/a. Then, the processing proceeds to the determination in step S21 illustrated in FIG. 20. On the other hand, when the condition is not satisfied (No in step S17), the processing proceeds to the determination in step S21 illustrated in FIG. 20 without adding the divisional arrangement obtained by zooming the long document image 41 for the long side size matching to the candidates.

Then, the image processor 12 determines whether the long document image 41 zoomed for the short side matching as in the example illustrated in FIG. 9 fits within the rearranged sheet 61 under the set condition (step S21). Note that the determination is performed for all the numbers of divisions N3 that are equal to or less than the predetermined upper limit value δ, as in the determinations in step S15 and step S17. That is, for all the numbers of divisions satisfying 0 < N3 ≤ δ, the numbers of divisions satisfying the condition are set as candidates. From the condition for matching the short side size of the long document image 41 with the rearranged sheet 61, a zoom magnification Z2 = (B/(A × N3)) × 100% is obtained for the long document image 41. The determination condition in step S21, i.e., √(a/b/P) < N3, is derived from the value of the magnification Z2, and the condition that the long side size of the zoomed long document image 41 is smaller than the long side size of the rearranged sheet 61. When the condition is satisfied (Yes in step S21), the divisional arrangement as in the example illustrated in FIG. 9 is set as a candidate (step S22). Such a condition related to the divisional arrangement condition/index 186 includes the short side of the sheet being equally divided by N3, the magnification being Z2 described above, and the number of pages being P. The unprinted area ratio of the sheet as an indicator is 1 - a/(N3 × N3 × b× P). Then, the processing proceeds to the determination in step S23. On the other hand, when the condition is not satisfied (No in step S21), the processing proceeds to the determination in step S23 without adding the divisional arrangement obtained by zooming the long document image 41 for the short side size matching to the candidates.

In step S23, the image processor 12 determines whether a divisional arrangement in which sheet pieces obtained by dividing the long side of the sheet as illustrated in FIGS. 11A and 11B are arranged in the direction of the sheet short side is to be also added to the candidates. That is, it is determined whether the item 36 for the long side division of the page setting screen 32 illustrated in FIG. 3 is set to "YES". When the item 36 for the long side division is set to "NO" (No in step S23), the image processor 12 subsequently determines whether the value of the number of pages P has reached the upper limit value (step S24). When the number of pages P has not reached the upper limit value yet (No in step S24), the image processor 12 increments the value of the number of pages P by one (step S26). Then, the processing returns to step S14 in FIG. 19, and the subsequent processing is executed for the value of the number of pages P updated. On the other hand, when the number of pages P has reached the upper limit value (Yes in step S24), No. 1 (final candidate) for each of the criteria set in advance such as "no division", "minimum unprinted area in minimum number of divisions", and "minimum unprinted area in minimum number of divisions for actual size" is extracted from the candidates, and the image processor 12 displays the divisional arrangement of each final candidate as in the candidate selection screen 181 illustrated in FIG. 18 to present the divisional arrangement to the user, and receives the selection by the user (step S25). Then, the processing is terminated.

On the other hand, in the determination in step S23 described above, when the item 36 for the long side division is set to "YES" (No in step S23), the image processor 12 advances the processing to the determination in step S27. In the determination in step S27, the image processor 12 determines whether the rearranged sheet 111 in which the sheet long side is equally divided by N as illustrated in FIGS. 11A and 11B and arrangement is performed in the short side direction is vertically long or horizontally long.

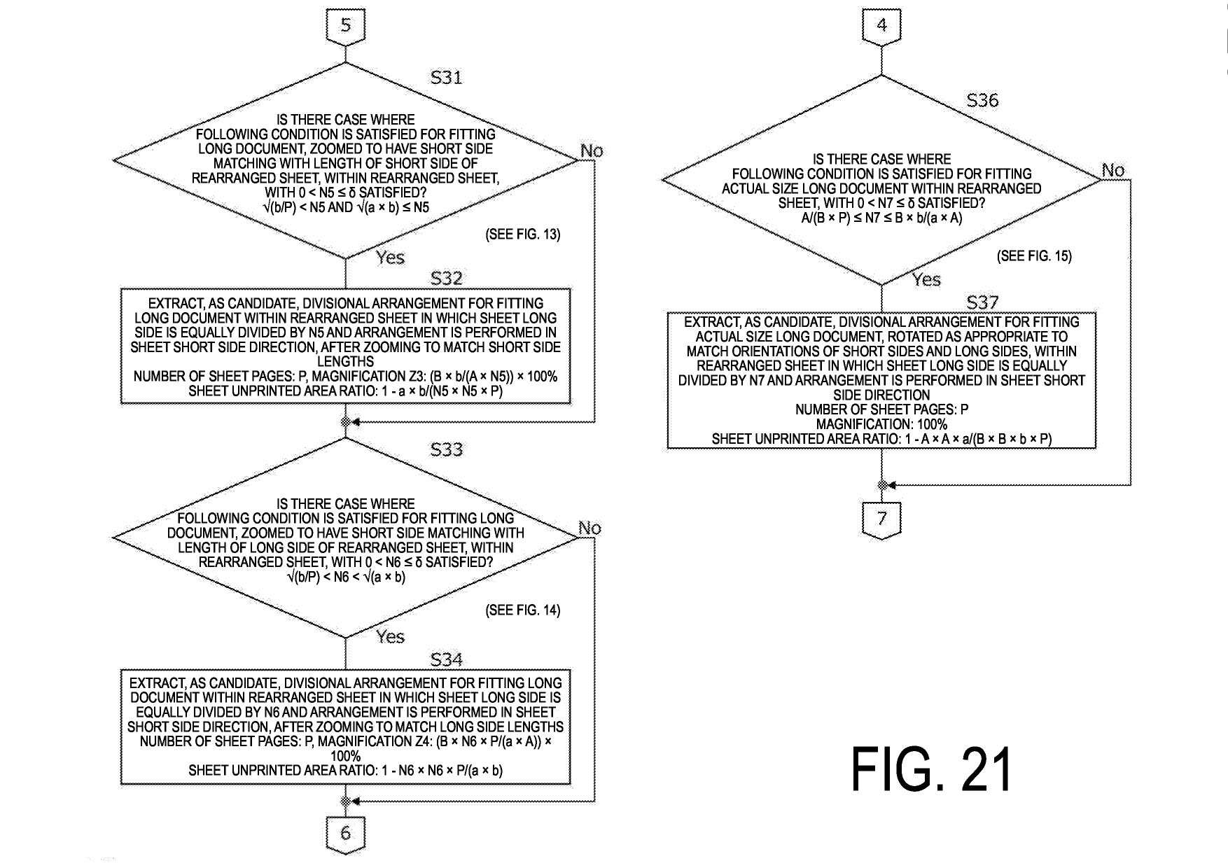

The condition N > √(b/P) illustrated in step S27 indicates that the short side of the sheet is on the long side of the rearranged sheet 111. When the short side of the sheet is on the long side of the rearranged sheet 111, the image processor 12 advances the processing to step S28. On the other hand, when the short side of the sheet is on the short side of the rearranged sheet 111, the image processor 12 advances the processing to step S36 in FIG. 21.

In the above-described step S27, when it is determined that the short side of the sheet is on the long side of the rearranged sheet 111 (Yes in step S27), the image processor 12 determines whether the long document image 101 of the actual size rotated as appropriate so as to match the orientations of the short sides and the long sides with the rearranged sheet 111 as in the example illustrated in FIG. 12 fits within the rearranged sheet 111 under the set condition (step S28). Note that the determination is performed over the entirety of the range of the numbers of divisions N4 that are equal to or less than a predetermined upper limit value δ. That is, for all the numbers of divisions satisfying 0 < N4 ≤ δ, the numbers of divisions satisfying the condition are set as candidates. One of the conditions making the long document image 101 fit within the rearranged sheet 111 is that the long side of the long document image 101 is equal to or shorter than the long side of the rearranged sheet 111. This condition corresponds to the condition (A × a)/(B × P) ≤ N4 in step S28. Another condition is that the short side of the long document image 101 is equal to or shorter than the short side of the rearranged sheet 111. This condition corresponds to the condition N4 ≤ (B × b)/A in step S28. When the condition is satisfied (Yes in step S28), the divisional arrangement as in the example illustrated in FIG. 12 is set as a candidate (step S29). Such a condition related to the divisional arrangement condition/index 186 includes the long side of the sheet being equally divided by N4, the magnification corresponding to the actual size (100%), and the number of pages being P. The unprinted area ratio of the sheet as an indicator is 1 - A × A × a/(B × B × b × P). Then, the processing proceeds to the determination in step S31 in FIG. 21. On the other hand, when the condition is not satisfied (No in step S28), the processing proceeds to the determination in step S31 in FIG. 21 without adding the divisional arrangement related to the long document image 101 of the actual size to the candidates.

Then, the image processor 12 determines whether the long document image 101 zoomed for the short side matching as in the example illustrated in FIG. 13 fits within the rearranged sheet 111 under the set condition (step S31). Note that the determination is performed for all the numbers of divisions N5 that are equal to or less than the predetermined upper limit value δ, as in the determination in step S28. That is, for all the numbers of divisions satisfying 0 < N5 ≤ δ, the numbers of divisions satisfying the condition are set as candidates. From the condition for matching the short side size of the long document image 101 with the short side of the rearranged sheet 111, a zoom magnification Z3 = (B × b/(A × N5)) × 100% is obtained for the long document image 101. The determination condition in step S31, i.e., √(a × b/P) ≤ N5, is derived from the value of the magnification Z3, and the condition that the long side size of the zoomed long document image 101 is smaller than the long side size of the rearranged sheet 111. When the condition is satisfied (Yes in step S31), the divisional arrangement as in the example illustrated in FIG. 13 is set as a candidate (step S32). Such a condition related to the divisional arrangement condition/index 186 includes the long side of the sheet being equally divided by N5, the magnification being Z3 described above, and the number of pages being P. The unprinted area ratio of the sheet as an indicator is 1 - a × b/(N5 × N5 × P). Then, the processing proceeds to the determination in step S33. On the other hand, when the condition is not satisfied (No in step S31), the processing proceeds to the determination in step S33 without adding the divisional arrangement obtained by zooming the long document image 101 for the short side size matching to the candidates.

Then, the image processor 12 determines whether the long document image 101 zoomed for the long side matching as in the example illustrated in FIG. 14 fits within the rearranged sheet 111 under the set condition (step S33). Note that the determination is performed for all the numbers of divisions N6 that are equal to or less than the predetermined upper limit value δ, as in the determinations in step S28 and step S31. That is, for all the numbers of divisions satisfying 0 < N6 ≤ δ, the numbers of divisions satisfying the condition are set as candidates. From the condition for matching the long side size of the long document image 101 with the long side of the rearranged sheet 111, a zoom magnification Z4 = (B × N6 × P/(a × A)) × 100% is obtained for the long document image 101. The determination condition in step S33, i.e., N6 ≤ √(a × b/P), is derived from the value of the magnification Z4, and the condition that the short side size of the zoomed long document image 101 is smaller than the short side size of the rearranged sheet 111. When the condition is satisfied (Yes in step S33), the divisional arrangement as in the example illustrated in FIG. 14 is set as a candidate (step S34). Such a condition related to the divisional arrangement condition/index 186 includes the long side of the sheet being equally divided by N6, the magnification being Z4 described above, and the number of pages being P. The unprinted area ratio of the sheet as an indicator is 1 - N6 × N6 × P/(a × b). Then, the processing returns to the determination in step S24 in FIG. 20. On the other hand, when the condition is not satisfied (No in step S33), the processing returns to the determination in step S24 in FIG. 20 without adding the divisional arrangement obtained by zooming the long document image 101 for the vertical direction size matching to the candidates.

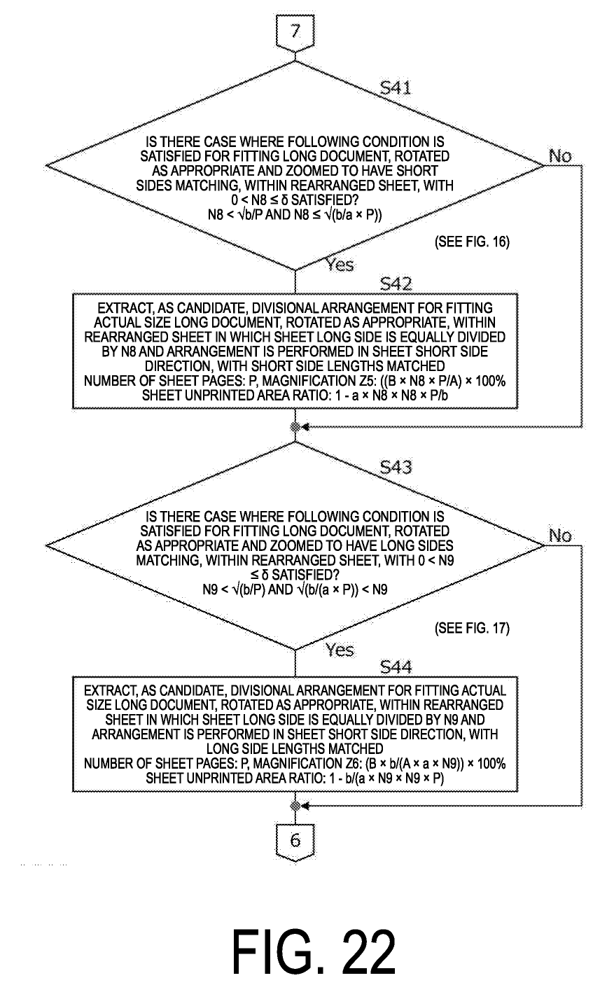

In the above-described step S27, when it is determined that the short side of the sheet is on the short side of the rearranged sheet 111 (No in step S27), the image processor 12 determines whether the long document image 101 of the actual size rotated as appropriate so as to match the orientations of the short sides and the long sides with the rearranged sheet 111 as in the example illustrated in FIG. 15 fits within the rearranged sheet 111 under the set condition (step S36). Note that the determination is performed over the entirety of the range of the numbers of divisions N7 that are equal to or less than a predetermined upper limit value δ. That is, for all the numbers of divisions satisfying 0 < N7 ≤ δ, the numbers of divisions satisfying the condition are set as candidates. One of the conditions making the long document image 101 fit within the rearranged sheet 111 is that the short side of the long document image 101 is equal to or shorter than the short side of the rearranged sheet 111. This condition corresponds to the condition A/(B × P) ≤ N7 in step S36. Another condition is that the long side of the long document image 101 is equal to or shorter than the long side of the rearranged sheet 111. This condition corresponds to the condition N7 ≤ (B × b)/(A × a) in step S36. When the condition is satisfied (Yes in step S36), the divisional arrangement as in the example illustrated in FIG. 15 is set as a candidate (step S36). Such a condition related to the divisional arrangement condition/index 186 includes the long side of the sheet being equally divided by N7, the magnification corresponding to the actual size (100%), and the number of pages being P. The unprinted area ratio of the sheet as an indicator is 1 - A × A × a/(B × B × b × P). Then, the processing proceeds to the determination in step S41 in FIG. 22. On the other hand, when the condition is not satisfied (No in step S36), the processing proceeds to the determination in step S41 in FIG. 22 without adding the divisional arrangement related to the long document image 101 of the actual size to the candidates.

Then, the image processor 12 determines whether the long document image 101 rotated as appropriate for matching the orientations of the short sides and the long sides with the rearranged sheet 111 and then zoomed for the short side matching as in the example illustrated in FIG. 16 fits within the rearranged sheet 111 under the set condition (step S41). Note that the determination is performed for all the numbers of divisions N8 that are equal to or less than the predetermined upper limit value δ, as in the determination in step S36. That is, for all the numbers of divisions satisfying 0 < N8 ≤ δ, the numbers of divisions satisfying the condition are set as candidates. From the condition for matching the short side size of the long document image 101 with the short side of the rearranged sheet 111, a zoom magnification Z5 = (B × N8 × P/A) × 100% is obtained for the long document image 101. The determination condition in step S41, i.e., N8 ≤ √(b/(a × P)), is derived from the value of the magnification Z5, and the condition that the long side size of the zoomed long document image 101 is smaller than the long side size of the rearranged sheet 111. When the condition is satisfied (Yes in step S41), the divisional arrangement as in the example illustrated in FIG. 16 is set as a candidate (step S42). Such a condition related to the divisional arrangement condition/index 186 includes the long side of the sheet being equally divided by N8, the magnification being Z5 described above, and the number of pages being P. The unprinted area ratio of the sheet as an indicator is 1 - a × N8 × N8 × P/b. Then, the processing proceeds to the determination in step S43. On the other hand, when the condition is not satisfied (No in step S41), the processing proceeds to the determination in step S43 without adding the divisional arrangement obtained by zooming the long document image 101 to have the short side size matched with the short side of the rearranged sheet 111, to the candidates.

Then, the image processor 12 determines whether the long document image 101 rotated as appropriate for matching the orientations of the short sides and the long sides with the rearranged sheet 111 and then zoomed for the long side matching as in the example illustrated in FIG. 17 fits within the rearranged sheet 111 under the set condition (step S43). Note that the determination is performed for all the numbers of divisions N9 that are equal to or less than the predetermined upper limit value δ, as in the determinations in step S36 and step S41. That is, for all the numbers of divisions satisfying 0 < N9 ≤ δ, the numbers of divisions satisfying the condition are set as candidates. From the condition for matching the short side size of the long document image 101 rotated as appropriate, with the rearranged sheet 111, a zoom magnification Z6 = (B × b/(A × a × N9)) × 100% is obtained for the long document image 101. The determination condition in step S43, i.e., N9 ≤ √(b/(a × P)), is derived from the value of the magnification Z6, and the condition that the short side size of the rotated as appropriate and zoomed long document image 101 is smaller than the short side size of the rearranged sheet 111. When the condition is satisfied (Yes in step S43), the divisional arrangement as in the example illustrated in FIG. 17 is set as a candidate (step S44). Such a condition related to the divisional arrangement condition/index 186 includes the long side of the sheet being equally divided by N9, the magnification being Z6 described above, and the number of pages being P. The unprinted area ratio of the sheet as an indicator is 1 - b/(a × N9 × N9 × P). Then, the processing returns to the determination in step S24 in FIG. 20. On the other hand, when the condition is not satisfied (No in step S43), the processing returns to the determination in step S24 in FIG. 20 without adding the divisional arrangement obtained by zooming the long document image 101 rotated as appropriate to have the long side size matched with the long side of the rearranged sheet 111, to the candidates.

The above is an example of the flow of the processing in which the image processor 12 determines and presents the candidate for the divisional arrangement. As illustrated in the flowcharts, if the values of A and a related to the document size, as well as the values of B and b related to the output size are determined, and the upper limit value of the number of pages P and the upper limit value of the number of divisions N are determined with the number of possible values of each of these being finite, the contents of the determination condition and the condition/index 186 can be determined as a combination thereof. In other words, the candidate for the divisional arrangement can be determined if the numbers of such values determined are finite.

### Second Embodiment

In the first embodiment, the upper limit value of the number of pages P is set in advance, and the image processor 12 presents, as candidates, divisional arrangements satisfying the condition of the number of pages equal to or less than the upper limit value. In this embodiment, when the user designates the number of pages P, the divisional arrangements satisfying other set conditions with the designated number of pages are presented as candidates. Although not illustrated in the page setting screen 32 of FIG. 3, in this embodiment, the page setting screen 32 is provided with settings of the number of pages P by the user, and receives the designation of the number of pages P by the user. The flow of the processing executed by the image processor 12 in this embodiment is substantially the same as the processing of the first embodiment illustrated in FIGS. 19 to 23. However, in the first embodiment, 1 is set as the initial value in step S13 of FIG. 19, whereas in this embodiment, the value of the number of pages P received on the page setting screen 32 is set. Further, the processing in step S24 and step S26 in FIG. 20 is omitted, and the processing proceeds to the route of Yes in step S24.

### Third Embodiment

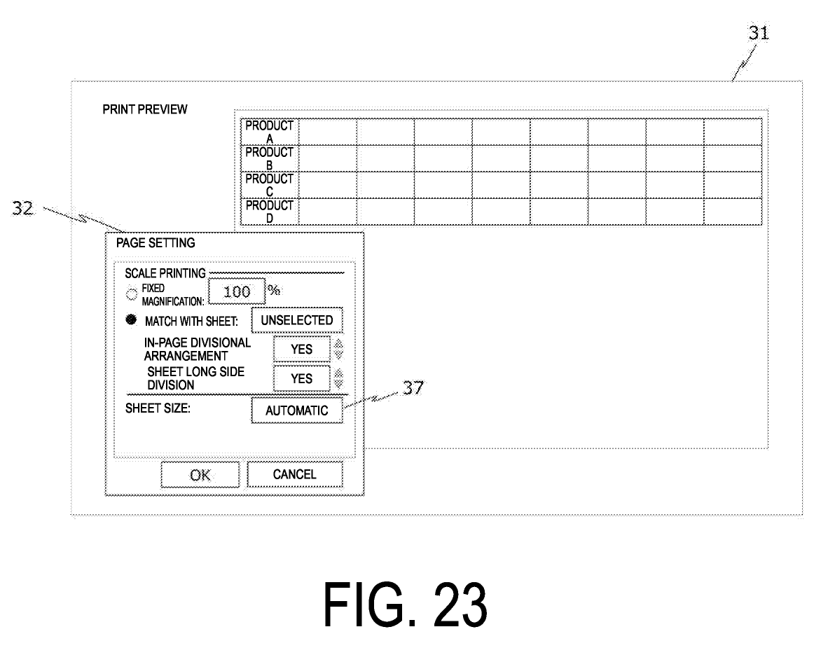

In the first embodiment, the setting 34 for matching the sheet size is received on the page setting screen 32, and the candidate for the divisional arrangement is determined for the set sheet size 37 (the A4 size in the example in FIG. 3). In contrast, in this embodiment, processing of determining divisional arrangement candidates for a finite number of sheet sizes, not only one set sheet size, and presenting the candidates to the user will be described. FIG. 23 is an explanatory diagram illustrating an example of a case where the sheet size 37 is set to "automatic" on the page setting screen 32 corresponding to FIG. 3. When the sheet size 37 is "automatic", the image processor 12 determines the candidate for the divisional arrangement for all the output sizes that can be processed by the image processing apparatus 10. For example, in the case of a copy job, the divisional arrangement candidates are determined for the respective sheet sizes set in the feed trays 16A to 16C. For example, in the case of a scanner job, the image processor 12 determines a candidate for the divisional arrangement for each of the output sizes that can be handled by the image processor 12. The divisional arrangement candidates can be determined if the number of types of output sizes is finite.

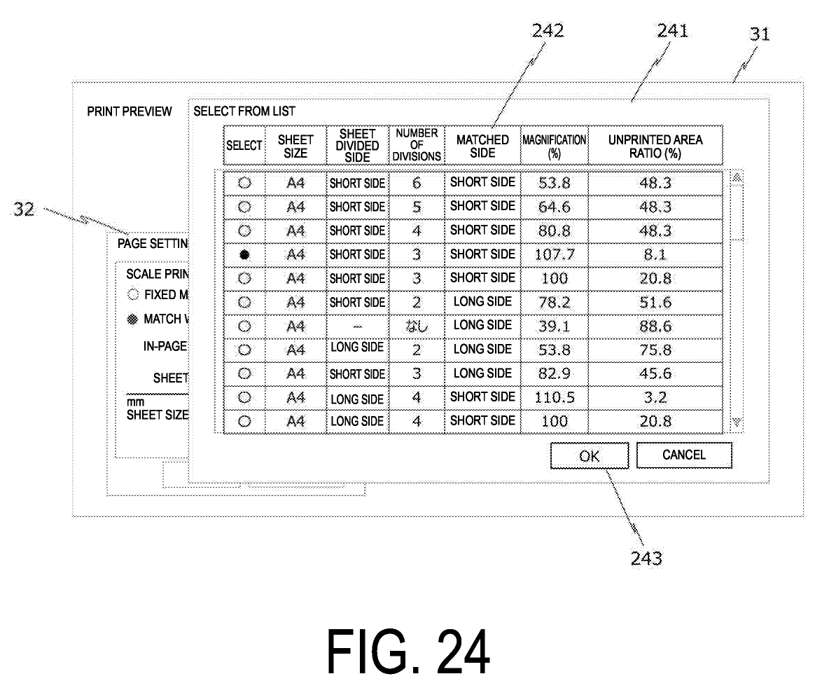

FIG. 24 is an explanatory diagram illustrating an example in which the image processor 12 determines the divisional arrangement candidates for possible sheet sizes and presents a list of the candidates to the user in this embodiment. As illustrated in FIG. 24, a candidate list screen 241 displays a list of the divisional arrangement candidates in a table format over a plurality of rows. For each candidate, a condition/index 242 is displayed. The items of the condition/index 242 are common to the condition/index 186 illustrated in FIG. 18. That is, the following items are displayed as the items of the condition/index 242 in the same row as the radio button for receiving the selection of the candidate. The sheet size, the sheet division side (which of the short side and the long side is equally divided), the number of divisions, the side to be matched (which of the short side and the long side of the long document image is matched with the vertical side of the sheet piece), and the magnification of the long document image are set. Further, as an index, the unprinted area ratio is displayed. In the table, all the sheet sizes happen to be A4, but if an A3 sheet is also contained in a feed tray, the result of the examination on the A4 sheet may be displayed and then the result of examination on the A3 sheet or the like may be displayed. Thus, the sheet size is not limited to one type. When an "OK" key 243 is operated, the selected candidate is output.

### Flowcharts

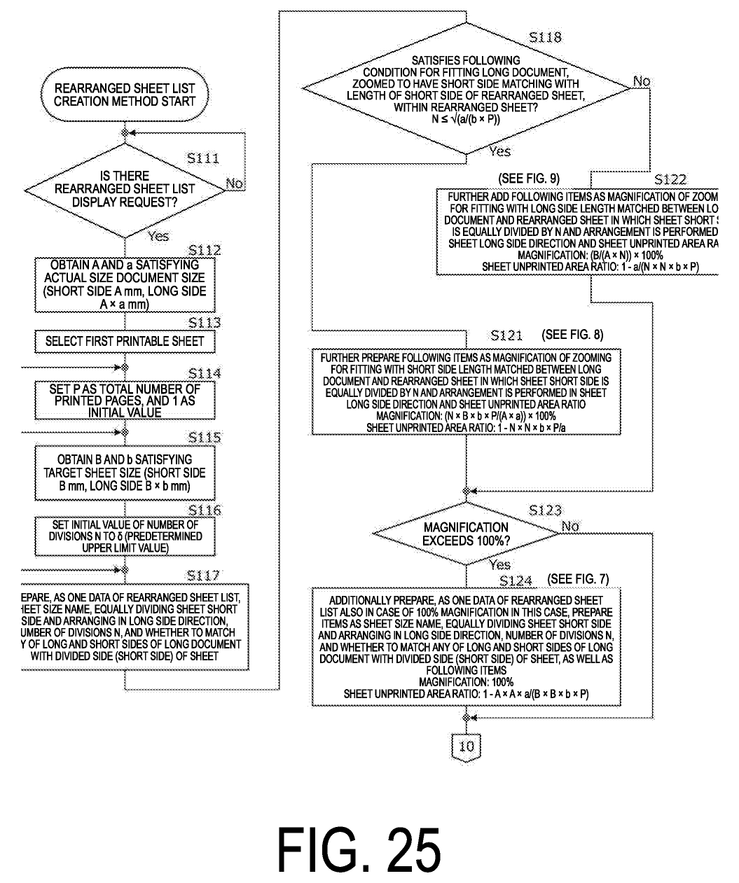

FIGS. 25 to 28 are flowcharts illustrating an example of a flow of processing in which the image processor 12 determines and presents a candidate for a divisional arrangement in this embodiment. The flow of the processing executed by the image processor 12 will be described with reference to these flowcharts. Note that FIGS. 25 to 28 illustrate an example of a copy job. As illustrated in FIG. 23, when the setting made by the user is received on the page setting screen 32 and it is determined that the setting is to determine the divisional arrangement of the long document and display the divisional arrangement in a list (step S111 illustrated in FIG. 25), the image processor 12 performs the following processing. First, the corresponding values of A and a for the document are acquired with A (mm) being the size in the short side direction and A × a being the size in the long side direction (step S112). FIGS. 4A and 10 illustrate A and a.

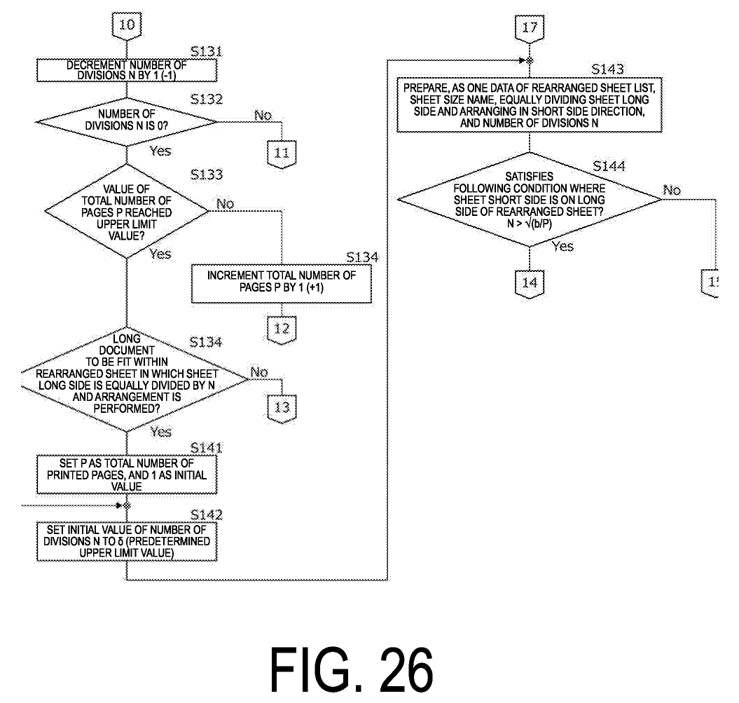

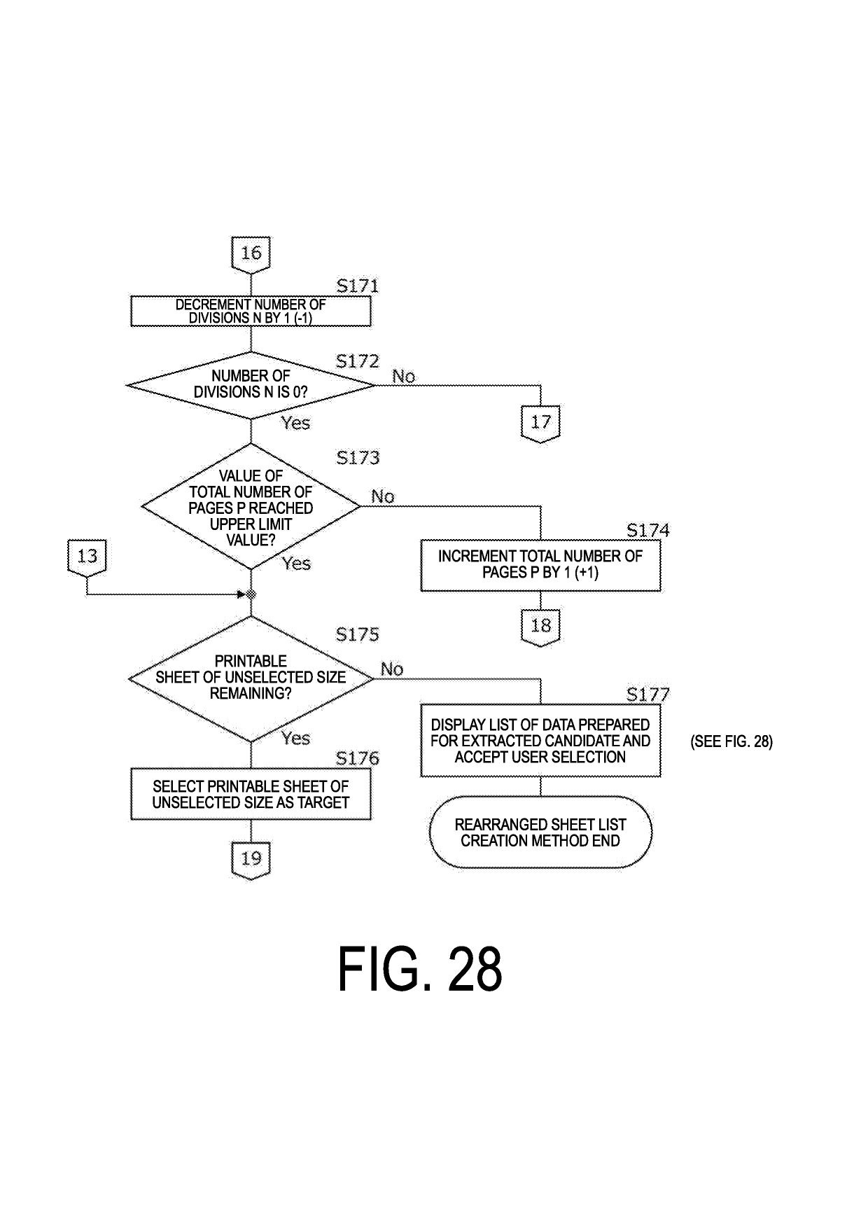

Subsequently, the image processor 12 selects the first sheet among the outputtable sheet sizes (step S113). Since the sheet size setting 37 is "automatic", the sheet sizes set in the feed trays 16A to 16C are selected in order from the sheet size set in the feed tray 16A. In steps S175 and S176 in FIG. 28, which will be described below, the target sheet size is sequentially switched, and the candidate for the divisional arrangement is determined for the sheet size. For example, when the sheet size setting 37 is "A4", the sheet size of A4 or A4R set in a printable feed tray is selected. Then, the number of pages P for which 1 is set as the initial value of the number of pages P to be output (step S114) is increased by 1 in steps S133 and S134 in FIG. 26, which will be described below, and candidates are determined for all the numbers of pages equal to or less than the upper limit value.

Subsequently, the image processor 12 acquires the corresponding values of B and b for the sheet size set in step S113 described above, that is, the output size, with B (mm) being the size of the short side direction and B × b being the size of the long side direction (step S115). Further, as an initial value of the number of divisions N, a predetermined upper limit value δ is set (step S116). As for the number of divisions N, the value is decremented by 1 in steps S131 and S132 in FIG. 26, which will be described below, and candidates are determined for all the numbers of divisions equal to or less than the upper limit value δ.

Then, in preparation for a case where the sheet size, the number of pages P, and the number of divisions N at that time point are candidates for the divisional arrangement, the sheet size, the sheet division side, the number of divisions N, and the side to be aligned are prepared as data so that the condition/index 242 can be presented on the candidate list screen 241 (step S117). It is preferable to also prepare the number of pages P as the condition/index 242. Here, the sheet division side is the short side of the sheet, and the side to be aligned is the short side of the long document image 101. This is because the divisional arrangement as illustrated in FIGS. 7 to 9 is assumed. Subsequently, the image processor 12 determines whether the long document image 41 fits within the rearranged sheet 61 if the size of the long document image 41 in the short side direction is zoomed in accordance with the size of the rearranged sheet 61 in the short side direction (step S118). That is, it is determined whether the divisional arrangement as illustrated in FIG. 8 can be a candidate. This is a determination as to whether N2 ≤ √(a/(b × P) is satisfied, which is the same condition as in step S17 in FIG. 19. When the condition is satisfied (Yes in step S118), the image processor 12 further prepares a magnification (N × B × b × P/(A × a)) × 100% and a sheet unprinted area ratio 1 - N × N × b × P/a, as the condition/index 242 (step S121). The magnification and the unprinted area ratio are the same as those in step S18 in FIG. 19. Then, the processing proceeds to the determination in step S123.

On the other hand, when the condition in step S118 described above is not satisfied (No in step S118), the image processor 12 further prepares a magnification ((B/(A × N)) × 100% and a sheet unprinted area ratio 1 - a/(N × N × b × P), as the condition/index 242 (step S122). The magnification and the unprinted area ratio are the same as those in step S22 in FIG. 20. Then, the processing proceeds to the determination in step S123.

In step S123, the image processor 12 determines whether the magnification obtained in step S121 or S122 exceeds 100%. If the long document image 41 fits within the rearranged sheet 61 even when the long document image 41 is enlarged to match with the vertical or horizontal size of the rearranged sheet 61, the long document image 41 of the actual size also fits within the rearranged sheet 61, and therefore, the long document image 41 is also added to the candidate for the divisional arrangement. That is, when the magnification exceeds 100% (Yes in step S123), the image processor 12 further prepares the magnification 100% and the unprinted area ratio 1 - A × A × a/(B × B × b × P) as the condition/index 242 (step S124). The magnification and the unprinted area ratio are the same as those in step S16 in FIG. 19. Then, the processing proceeds to step S131 illustrated in FIG. 26. On the other hand, when the condition in step S123 described above is not satisfied (No in step S123), the processing proceeds to step S131 illustrated in FIG. 26 without adding the divisional arrangement related to the actual-size long document image to the candidates.

In FIG. 26, the image processor 12 decrements the value of the number of divisions N by one (step S131), and determines whether the value of the number of divisions N is zero (step S132). When the value of the number of divisions N is not zero (No in step S132), the processing returns to step S117 in FIG. 25, and the subsequent processing is executed for the value of the number of divisions N. When the value of the number of divisions N is zero (Yes in step S132), it is determined that the determination of the candidates has been performed for all the possible values of the number of divisions N, and it is then determined whether the value of the number of pages P has reached the upper limit value (step S133). When the value of the number of pages P has not reached the upper limit value yet (No in step S133), the number of pages P is incremented by one (step S134), the processing returns to step S115 in FIG. 25, and the subsequent processing is executed for the number of pages P. On the other hand, when the value of the number of pages P has reached the upper limit value (Yes in step S133), it is determined that the determination of the candidates has been performed for all the possible values of the number of pages P. Then, the image processor 12 determines whether to set, as a candidate, a divisional arrangement with which the long document image 101 as illustrated in FIG. 10 fits within the rearranged sheet 111 in which the sheet pieces are arranged as a result of dividing the long side of the sheet in the short side direction as illustrated in FIGS. 11A and 11B (step S134).

When the divisional arrangement with which the long document image 101 as illustrated in FIG. 10 fits within the rearranged sheet 111 as illustrated in FIGS. 11A and 11B is not set to be a candidate (No in step S134), the image processor 12 advances the processing to step S175 illustrated in FIG. 28 and determines whether there is an unselected possible output size. When there are unselected possible output sizes (Yes in step S175), one of the unselected possible output sizes is selected (step S176). Then, the processing returns to step S114 in FIG. 25, and the subsequent processing is executed for the selected output size. On the other hand, when there is no unselected possible output size, it is determined that the determination of the candidate has been performed for all the possible output sizes (No in step S175). Then, the processing proceeds to step S177, and the data prepared for the divisional arrangement candidates is displayed in a list on the candidate list screen 241. Then, the user's selection of the divisional arrangement candidate displayed in the list is received.

In the determination in step S134 in FIG. 26 described above, the divisional arrangement with which the long document image 101 as illustrated in FIG. 10 fits within the rearranged sheet 111 as illustrated in FIGS. 11A and 11B is set to be a candidate (Yes in step S134), the image processor 12 continues to the following processing. First of all, the number of pages P for which 1 is set as the initial value of the number of pages P (step S141) are increased by 1 in steps S173 and S174 in FIG. 28, which will be described below, and candidates are determined for all the numbers of pages equal to or less than the upper limit value. Further, as an initial value of the number of divisions N, a predetermined upper limit value δ is set (step S142). As for the number of divisions N, the value is decremented by 1 in steps S171 and S172 in FIG. 28, which will be described below, and candidates are determined for all the numbers of divisions equal to or less than the upper limit value δ.

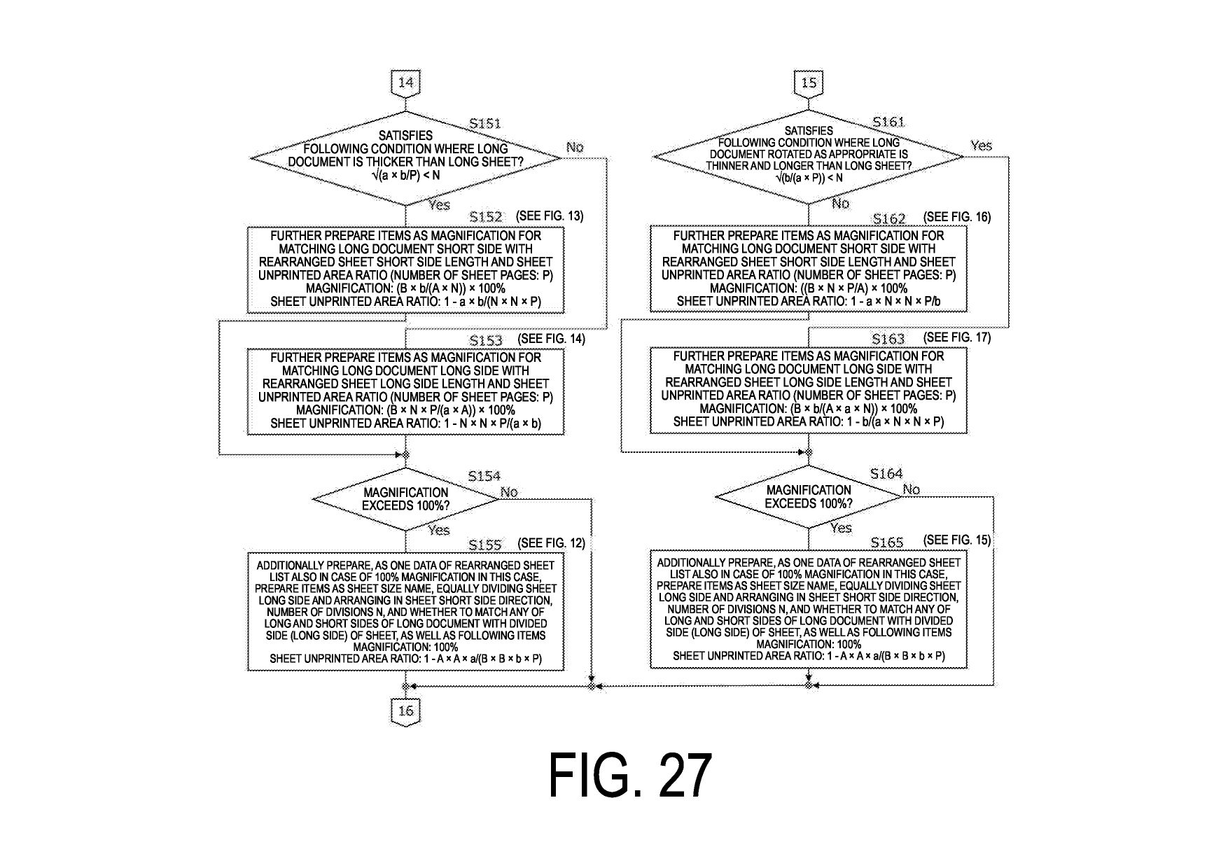

Then, in preparation for a case where the sheet size, the number of pages P, and the number of divisions N at that time point are candidates for the divisional arrangement, the sheet size, the sheet division side, and the number of divisions N are prepared as data so that the condition/index 242 can be presented on the candidate list screen 241 (step S143). It is preferable to also prepare the number of pages P as the condition/index 242. Here, the sheet division side is the long side of the sheet. This is because the divisional arrangement as illustrated in FIGS. 12 to 17 is assumed. Subsequently, the image processor 12 determines whether the short side of the sheet is on the long side of the rearranged sheet 111 (step S144). This is the same as the determination in step S27 in FIG. 20. When the short side of the sheet is on the long side of the rearranged sheet (Yes in step S144), the processing proceeds to the determination in step S151 illustrated in FIG. 27.

In the determination in step S151 in FIG. 27, the image processor 12 determines whether the long document image 101 fits within the rearranged sheet if the short side of the long document image 111 is zoomed in accordance with the short side of the rearranged sheet 111. That is, it is determined whether the divisional arrangement as illustrated in FIG. 13 can be a candidate. Step S151 is a determination of whether the same condition as step S31 in FIG. 21, that is, √(a × b/P) < N, is satisfied. When the condition is satisfied (Yes in step S151), the image processor 12 further prepares a magnification (B × b/(A × N)) × 100% and a sheet unprinted area ratio 1 - a × b/(N × N × P) as the condition/index 242 (step S152). The magnification and the unprinted area ratio are the same as those in step S32 in FIG. 21. Then, the processing proceeds to the determination in step S154.

On the other hand, when the condition in step S151 described above is not satisfied (No in step S151), the image processor 12 further prepares a magnification (B × N × P/(a × A)) × 100% and a sheet unprinted area ratio 1 - N × N × P/(a × b) as the condition/index 242 (step S153). The magnification and the unprinted area ratio are the same as those in step S34 in FIG. 21. Then, the processing proceeds to the determination in step S154.

In step S154, the image processor 12 determines whether the magnification obtained in step S152 or S153 exceeds 100%. If the long document image 101 fits within the rearranged sheet 111 even when the long document image 101 is enlarged to match with the size of the short side or the long side of the rearranged sheet 111, the long document image 101 of the actual size also fits within the rearranged sheet 111, and thus the long document image is also added to the candidates for the divisional arrangement. That is, when the magnification exceeds 100% (Yes in step S154), the image processor 12 further prepares the magnification 100% and the unprinted area ratio 1 - A × A × a/(B × B × b × P) as the condition/index 242 (step S155). The magnification and the unprinted area ratio are the same as those in step S29 in FIG. 20. Then, the processing proceeds to step S171 illustrated in FIG. 28. On the other hand, when the condition in step S154 described above is not satisfied (No in step S154), the processing proceeds to step S171 illustrated in FIG. 28 without adding the divisional arrangement related to the actual-size long document image to the candidates.

Returning to the determination in step S144 in FIG. 26 described above, when the sheet short side is on the short side of the rearranged sheet 111 (No in step S144), the processing proceeds to the determination in step S161 illustrated in FIG. 27.

In the determination in step S161 in FIG. 27, the image processor 12 determines whether the long document image 101 rotated as appropriate fits within the rearranged sheet if the short side of the long document image 111 is zoomed in accordance with the short side of the rearranged sheet 111. That is, it is determined whether the divisional arrangement as illustrated in FIG. 16 can be a candidate. Step S161 is a determination of whether the same condition as step S41 in FIG. 22, that is, √(b/(a × P)) < N, is satisfied. When the condition is not satisfied (No in step S161), the image processor 12 further prepares a magnification (B × N × P/A) × 100% and a sheet unprinted area ratio 1 - a × N × N × P/b as the condition/index 242 (step S162). The magnification and the unprinted area ratio are the same as those in step S42 in FIG. 22. Then, the processing proceeds to the determination in step S164.

On the other hand, when the condition in step S161 is satisfied (Yes in step S161), the image processor 12 further prepares the magnification (B × b/(A × a × N)) × 100% and the sheet unprinted area ratio 1 - b/(a × N × N × P) as the condition/index 242 (step S163). The magnification and the unprinted area ratio are the same as those in step S44 in FIG. 22. Then, the processing proceeds to the determination in step S164.

In step S164, the image processor 12 determines whether the magnification obtained in step S162 or S163 exceeds 100%. If the long document image 101 fits within the rearranged sheet 111 even when the long document image 101 rotated as appropriate is enlarged to match with the size of the short side or the long side of the rearranged sheet 111, the long document image 101 of the actual size also fits within the rearranged sheet 111, and thus the long document image is also added to the candidates for the divisional arrangement. That is, when the magnification exceeds 100% (Yes in step S164), the image processor 12 further prepares the magnification 100% and the unprinted area ratio 1 - A × A × a/(B × B × b × P) as the condition/index 242 (step S165). The magnification and the unprinted area ratio are the same as those in step S37 in FIG. 21. Then, the processing proceeds to step S171 illustrated in FIG. 28. On the other hand, when the condition in step S154 described above is not satisfied (No in step S154), the processing proceeds to step S171 illustrated in FIG. 28 without adding the divisional arrangement related to the actual-size long document image to the candidates.

In FIG. 28, the image processor 12 decrements the value of the number of divisions N by one (step S171), and determines whether the value of the number of divisions N is zero (step S172). When the value of the number of divisions N is not zero (No in step S172), the processing returns to step S143 in FIG. 26, and the subsequent processing is executed for the value of the number of divisions N. When the value of the number of divisions N is zero (Yes in step S172), it is determined that the determination of the candidates has been performed for all the possible values of the number of divisions N, and it is then determined whether the value of the number of pages P has reached the upper limit value (step S173). When the value of the number of pages P has not reached the upper limit value yet (No in step S173), the number of pages P is incremented by one (step S174), the processing returns to step S142 in FIG. 26, and the subsequent processing is executed for the number of pages P. On the other hand, when the value of the number of pages P has reached the upper limit value (Yes in step S173), it is determined that the determination of the candidates has been performed for all the possible values of the number of pages P.

Then, the image processor 12 determines whether there is any possible output size that has not been selected (step S175). When there are unselected possible output sizes (Yes in step S175), one of the unselected possible output sizes is selected (step S176). Then, the processing returns to step S114 in FIG. 25, and the subsequent processing is executed for the selected output size. On the other hand, when there is no unselected possible output size, it is determined that the determination of the candidate has been performed for all the possible output sizes (No in step S175). Then, the processing proceeds to step S177, and the data prepared for the divisional arrangement candidates is displayed in a list on the candidate list screen 241. Then, the user's selection of the divisional arrangement candidate displayed in the list is received.

The above is an example of the flow of the processing in which the image processor 12 determines the candidate for the divisional arrangement in this embodiment.

### Other Modifications

The first to the third embodiments present examples in which, in accordance with a predetermined priority condition, a candidate for a preferred divisional arrangement is presented to a user, a selection by the user is received, and the selected candidate is output to the user. As a modification, a mode is also conceivable in which the user sets a priority condition in advance, and the image processor 12 determines and outputs an optimal candidate for the divisional arrangement in accordance with the set priority condition.

It should be understood that the disclosure also includes combinations of any of the aforementioned plurality of aspects.

Various modifications of the invention are also possible as well as the aforementioned embodiments. It should not be understood that those modifications do not belong to the scope of the present invention. The present invention should include all modifications belonging to the meaning equivalent to the scope of the claims and the scope of the disclosure.

### Reference Signs List

10: image processing apparatus, 11: document image acquirer, 12: image processor, 12D: actual size document divider, 12L: divisional arrangement determiner, 12S: rearrangement output size calculator, 12Z: zoom document divider, 13: image outputter, 14: document reader 14F: document feeder, 14P: platen, 15: communicator, 16: printing unit, 16A to 16C: feed tray, 16D to 16F: discharge tray, 17: operation inputter, 18: operation controller, 19: one or more controllers, 31: preview screen, 32: page setting screen, 33: radio button, 34: sheet size, 35: in-page divisional arrangement, 36: long side division, 37: document size, 38: direct input field, 39, 187, 243: "OK" key, 41, 101: long document image, 51, 51-1 to 51-P: output size, 61, 111: rearranged sheet, 181: candidate selection screen, 182, 183, 184: priority condition, 185: thumbnail, 186, 242: condition/index, 241: candidate list screen

1. An image processing method for divisional arrangement of a plurality of document image pieces, obtained by dividing a long document image, into a number of pages P smaller than number of the document image pieces, the image processing method comprising, by a processor:
obtaining, for one output size or more, a size of a rearranged sheet in which N × P sheet pieces each having a length of one side obtained by equally dividing any one of vertical and horizontal sides of the output size by a number of divisions N, and having a length of another side that is equal to a length of another one of the sides of the output size, in a direction along the other side;
determining whether the long document image of an actual size fits within the size of the rearranged sheet, and when the long document image fits within the size, determining, as an outputtable arrangement, a divisional arrangement including a plurality of actual size document image pieces obtained by dividing the long document image at a position corresponding to each sheet piece;
determining whether the long document image fits within the size of the rearranged sheet when the long document image is zoomed to match the size of any of the short side and the long side of the rearranged sheet, and when the long document image fits within the size, determining, as an outputtable arrangement, a divisional arrangement including a plurality of zoomed document image pieces obtained by dividing the zoomed long document image at a position corresponding to each sheet piece; and
obtaining, as an outputtable image, an image of the P pages in which a maximum of N document image pieces according to the divisional arrangement determined to be outputtable are arranged per page in an arrangement order of the original long document image, wherein
N and P are both natural numbers.

2. The image processing method according to claim 1, further comprising:
determining, regarding a size selected by a user or one or more outputtable sizes and for one long document image, whether there is a divisional arrangement outputtable for a condition different in at least one of following (1) to (4):
(1) the number of divisions N;
(2) which of the vertical and horizontal sides of the output size is equally divided by N;
(3) a magnification related to the zoom; and
(4) the number of pages P;
presenting, when there is one or more divisional arrangements determined to be outputtable, the one or more divisional arrangements to a user together with at least one of the applied items (1) to (4); and
receiving a selection of the presented divisional arrangement by a user.

3. The image processing method according to claim 2, wherein the presenting includes presenting, to the user, information related to an area of a long document image that is of an actual size or zoomed related to the divisional arrangement and to an area of the rearranged sheet, in addition to the at least one of the applied items (1) to (4).

4. The image processing method according to claim 3, wherein the presenting includes presenting the outputtable divisional arrangement to a user in descending order of a ratio of the area of the long document image that is of the actual size or zoomed in the rearranged sheet.

5. The image processing method according to claim 2, wherein the number of divisions N is a number in a range determined in advance according to a size and an aspect ratio of the long document image and a size and an aspect ratio of the image to be output.

6. The image processing method according to claim 2, wherein
the long document image includes a character, and
the number of divisions N is a number in a range determined to enable a size of the character in the long document image to fit within a size of a predetermined range.

7. The image processing method according to claim 1, further comprising determining a divisional arrangement of a condition achieving a highest ratio of an area of the long document image that is of the actual size or zoomed in the rearranged sheet, and outputting the image based on the divisional arrangement.

8. An image processing apparatus for divisional arrangement of a plurality of document image pieces, obtained by dividing a long document image, into a number of pages P smaller than number of the document image pieces, the image processing apparatus comprising:
a document image acquirer that acquires the long document image;
an image processor that generates an image obtained by divisionally arranging the long document image acquired; and
an image outputter that outputs the image, wherein
the image processor includes
a rearrangement output size calculator that obtains, for one output size or more, a size of a rearranged sheet in which N × P sheet pieces each having a length of one side obtained by equally dividing any one of vertical and horizontal sides of the output size by a number of divisions N, and having a length of another side that is equal to a length of another one of the sides of the output size, in a direction along the other side,
an actual size document divider that determines whether the long document image of an actual size fits within the size of the rearranged sheet, and determines, when the long document image fits within the size, a divisional arrangement including a plurality of actual size document image pieces obtained by dividing the long document image at a position corresponding to each sheet piece as an outputtable arrangement,
a zoom document divider that determines whether the long document image fits within the rearranged sheet when the long document image is zoomed to match the size of any of the short side and the long side of the rearranged sheet, and when the long document image fits within the size, determines, as an outputtable arrangement, a divisional arrangement including a plurality of zoomed document image pieces obtained by dividing the zoomed long document image at a position corresponding to each sheet piece, and
a divisional arrangement determiner that obtains, as an outputtable image, an image of the P pages in which a maximum of N document image pieces according to the divisional arrangement determined to be outputtable are arranged per page in an arrangement order of the original long document image,
the image outputter outputs any of the outputtable images, and
N and P are both natural numbers.

9. An image processing program for divisional arrangement of a plurality of document image pieces, obtained by dividing a long document image, into a number of pages P smaller than number of the document image pieces, the image processing program causing a processor to execute processing comprising:
obtaining, for one output size or more, a size of a rearranged sheet in which N × P sheet pieces each having a length of one side obtained by equally dividing any one of vertical and horizontal sides of the output size by a number of divisions N, and having a length of another side that is equal to a length of another one of the sides of the output size, in a direction along the other side;
determining whether the long document image of an actual size fits within the size of the rearranged sheet, and when the long document image fits within the size, determining, as an outputtable arrangement, a divisional arrangement including a plurality of actual size document image pieces obtained by dividing the long document image at a position corresponding to each sheet piece;
determining whether the long document image fits within the size of the rearranged sheet when the long document image is zoomed to match the size of any of the short side and the long side of the rearranged sheet, and when the long document image fits within the size, determining, as an outputtable arrangement, a divisional arrangement including a plurality of zoomed document image pieces obtained by dividing the zoomed long document image at a position corresponding to each sheet piece; and
obtaining, as an outputtable image, an image of the P pages in which a maximum of N document image pieces according to the divisional arrangement determined to be outputtable are arranged per page in an arrangement order of the original long document image, wherein
N and P are both natural numbers.
